(19) United States
(12) Patent Application Publication
(10) Pub. No.: US 2013/0072404 A1
(43) Pub. Date: Mar. 21, 2013

(54) APPARATUS AND PROCESSES FOR GENERATING VARIABLE CONCENTRATION OF SOLUTES IN MICRODROPLETS

(71) Applicants: Oliver Jon Miller, Strasbourg (FR); Lucas Frenz, Strasbourg (FR); Andrew David Griffiths, Strasbourg (FR); Christoph Merten, Bottrop (DE); Abdeslam El Harrak, Faulquemont (FR)

(72) Inventors: Oliver Jon Miller, Strasbourg (FR); Lucas Frenz, Strasbourg (FR); Andrew David Griffiths, Strasbourg (FR); Christoph Merten, Bottrop (DE); Abdeslam El Harrak, Faulquemont (FR)

(73) Assignees: UNIVERSITE DE STRASBOURG, STRASBOURG (FR); CENTRE NATIONAL DE LA RECHERCHE SCIENTIFIQUE, PARIS (FR)

(21) Appl. No.: 13/500,697

(22) PCT Filed: Oct. 7, 2010
(86) PCT No.: PCT/EP2010/065034

§ 371 Date: Dec. 3, 2012

Related U.S. Application Data
(60) Provisional application No. 61/249,689, filed on Oct. 8, 2009.

(51) Int. Cl. G01N 1/28

(52) U.S. Cl. CPC G01N 1/28
USPC 506/11; 435/18; 422/502

(57) ABSTRACT

The present invention relates to systems and methods for generating microdroplets with varying concentrations of a particular solute from a solution at fixed concentration.

### FIELD OF THE INVENTION

The present invention is directed to systems and methods for generating microdroplets with varying concentrations of a particular solute from a solution at fixed concentration.

### BACKGROUND OF THE INVENTION

Droplet microfluidics is the technology concerned with the formation, transportation, and interaction of microdroplets within microfluidic devices. Typically, microdroplets of one phase are generated in another, immiscible phase by exploiting capillary instabilities in a microfluidic two-phase flow (Anna et al., 2003). The addition of a surfactant to either or both of the phases stabilizes the microdroplets against coalescence and allows them to function as discrete microreactors. A wide range of chemical and biological reactions can be performed inside aqueous microdroplets, including: the synthesis of magnetic iron oxide nanoparticles (Frenz et al., 2008), DNA/RNA amplification (Mazutis et al., 2009), in vitro transcription/translation (Courtois et al., 2008), enzymatic catalysis (Baret et al., 2009), and cell-based assays (Clausell-Tormos et al., 2008; Brouzes et al., 2009). The tiny size of the microdroplets—1 pico liter to 1 nano liter in volume—facilitates extremely high throughputs (10⁴ samples per second) and vastly reduced reagent consumption.

However, the use of micro fluidic-based systems for measuring dose-response relationships, and in particular to perform high throughput screening, is limited by methods of achieving dilutions in microfluidics. A typical method of achieving dilutions in microfluidics is co-flowing two streams into a single outlet channel. The output channel is filled laminarly by the buffer and compound stream and the achieved output concentration depends linearly on the input flow-rates and therefore on the percentage the two laminar phases occupy within the output channel. Such a system could be reasonable for lower dilutions, possibly up to one or two orders of magnitude, but is very unstable and error prone at higher dilutions. As in the macroscopic world, serial dilution is therefore the logical consequence. The system needs to generate several pre-diluted output streams and then selectively perform smaller dilutions within those. Technically microfluidics offers this opportunity to generate pre-dilutions passively. Analogue to electrical resistor networks, channel resistances and interconnections may be designed. This system leads to several different output channels, each one with a dilution of the previous one. When using such system, the main challenge is to selectively use one of these output streams, which is technically very demanding and error prone.

Consequently, there is a need in the art for a facile technique capable of generating droplets containing a wide range of concentrations, with small steps in concentration.

### SUMMARY OF THE INVENTION

The object of the present invention is to provide new methods and systems for generating microdroplets with variable concentrations of a solute.

In a first aspect, the invention provides a method for generating variable concentration of a solute in microdroplets.

In a first embodiment, the method for generating variable concentration of a solute in microdroplets comprises

(a) flowing a solvent into a microfluidic channel in a laminar manner;

(b) introducing a pulse of a solute to the stream of solvent;

(c) flowing the stream containing the solvent and the solute along the channel; and

(d) generating microdroplets by combining the output stream of the channel with an oil phase, said microdroplets containing variable concentration of the solute.

Preferably, during step (c) the solute disperses into the solvent due to Taylor-Aris dispersion. The method may further comprise calculating the concentration of the solute in microdroplets generated in step (d) using the theoretical Taylor-Aris dispersion and the diffusion coefficient of the solute. The method may also comprise measuring the diffusion coefficient of the solute or estimating the diffusion coefficient of the solute from its molecular weight and its shape. The diffusion coefficient of the solute may be measured by determining the concentration profile of the solute after step (c) and before step (d) and calculating the diffusion coefficient of the solute using the following equation representing the concentration of the solute (C) at a fixed point (Lₘ) in the channel as a function of time (t)

$$C ( {L}_{m} , t ) = \frac{{C}_{0}}{2} ( erf \frac{{L}_{m} + {L}_{p} - Ut}{\sqrt{4 {D}_{eff} t}} - erf \frac{{L}_{m} - Ut}{\sqrt{4 {D}_{eff} t}} )$$

wherein C₀ is the original concentration of the solute in the pulse, erf( ) is the Gauss error function, Lₚ is the original length of the solute pulse in the microfluidic channel, U is the average velocity of the fluid in the microfluidic channel and D_{eff} is the diffusion coefficient of the solute. The concentration profile of the solute after step (c) and before step (d) may be measured using refractive index, UV or IR absorption or mass spectrometry, preferably refractive index.

In a second embodiment, the method for generating variable concentration of a solute in microdroplets comprises

(a) providing a micro fluidic system comprising at least two inlet channels that intersect to form a microfluidic channel, said microfluidic channel comprising three output channels, at least two of which are connected to a separate means for controlling and varying the flow, the central output channel containing the output stream of the channel, said central output channel being in fluid communication with a module for generating microdroplets;

(b) flowing a first fluid in one inlet channel and an at least one second fluid containing a solute in another inlet channel, the interface formed between the fluids in the microfluidic channel persisting for the length of the channel

(c) varying the relative flow rates into the outer output channels;

(d) generating microdroplets by combining the output stream of the central channel with an oil phase, said microdroplets containing variable concentration of the solute.

Preferably, in step (a), the at least two output channels which are connected to a separate means for controlling and varying the flow, are the two outer output channels. Preferably, means for controlling and varying the flow are aspirating pumps.

Step (b) may comprise flowing several second fluids, each of these fluids containing a different concentration of the solute.

The method may further comprise, after step (c) and before or after step (d), the step (c′) of combining the output stream of the channel with one or several additional fluids. Optionally, at least one additional fluid is contained in an additional set of droplets and the method further comprises, after step (d), the step (d′) of fusing said droplets with droplets generated in step (d).

In a second aspect, the invention provides a method for determining a dose-response relationship in an at least two component system, said method comprising

(1) generating variable concentration of a solute in microdroplets with the method for generating variable concentration of a solute in microdroplets according to the invention, wherein the solute is a first component of the at least two component system and one additional fluid contains a second component of the system; and

(2) measuring the response of the at least two component system in each microdroplet.

In an embodiment, the second component is an enzyme and the first component is a substrate of said enzyme. In another embodiment, the second component is an enzyme and the first component is an inhibitor or an activator of said enzyme and a second additional fluid containing a substrate of the enzyme is combined in microdroplets with the first and second components. In another embodiment, the second component is a target molecule and the first component is a ligand for said target molecule. Target molecule may be selected from the group consisting of a peptide, a protein, an enzyme, an antibody, a receptor, a nucleic acid or a cell. The ligand of the target protein may be selected from the group consisting of a enzyme substrate, an enzyme inhibitor, an enzyme cofactor, an antigen, a ligand receptor and a nucleic acid binding protein. In another embodiment, the second component is a cell.

The response of the system may measured by quantifying an optical signal. The optical signal may be emitted by the product of the reaction between the components of the system. Preferably, the optical signal is fluorescent signal.

The method may further comprise step (3) of plotting the response of the system in each microdroplet.

When the second component is an enzyme and the first component is a substrate of said enzyme, the method may further comprise step (4) of determining the Michaelis and/or Vₘₐₓ constants of the system.

When the second component is an enzyme, the first component is an inhibitor or an activator of said enzyme and a second additional fluid containing a substrate of the enzyme is combined in microdroplets with the first and second components, the method may further comprises step (4) of determining an effective concentration value of the activator in said system, preferably EC₂₀, EC₅₀ or EC₉₀, or an inhibitory concentration value of the inhibitor in said system, preferably IC₂₀, IC₅₀ or IC₉₀.

The concentration of the solute in microdroplets may be measured by assessing the concentration of a reporter molecule mixed with said solute. The reporter molecule may be a fluorescent dye, preferably a far-red or near-infrared fluorescent dye. Optionally, the method may further comprise step (5) of refining the measured concentration of the solute in microdroplets by taking into account the difference between the diffusion coefficients of the solute and the reporter molecule.

The concentration of the solute in microdroplets may also be calculated by estimating the concentration profile of the solute in the output stream of the channel.

In a third aspect, the invention provides a method for screening, selecting or identifying a compound active on a target component, said method comprising

(1) providing a library of candidate compounds;

(2) generating for each candidate compound provided in step (1) a population of microdroplets with variable concentration of said candidate compound with the method for generating variable concentration of a solute in microdroplets according to the invention, wherein the solute is the candidate compound and one additional fluid contains the target component;

(3) measuring the activity of said candidate compounds on the target component in microdroplet; and

(4) identifying candidate compounds which are active on the target component.

Preferably, the target component is selected from the group consisting of nucleic acid, protein, enzyme, receptor, protein complex, protein-nucleic acid complex and cell.

In a fourth aspect, the invention further provides a microfluidic system comprising
a module for generating variable concentrations of a solute in a solvent;
a module for generating droplets connected downstream of the module for generating variable concentrations.

In a first embodiment, the module for generating variable concentrations of a solute in a solvent is a micro fluidic channel connected to means for introducing a pulse of solute to a stream of solvent flowing along said channel. The micro fluidic channel may be a capillary with an internal diameter ranging from 25 μm to 1 mm, preferably from 50 μm to 500 μm. The microfluidic channel may be a capillary with a length ranging from 1 cm to 1 m, preferably from 25 cm to 75 cm. Means for introducing a pulse of solute to a stream of solvent flowing along said channel may be an autosampler.

In a second embodiment, the module for generating variable concentrations of a solute in a solvent comprises at least two inlet channels that intersect to form a microfluidic channel, said microfluidic channel comprising three output channels, at least two of which are connected to separate means for controlling and varying the flow, and the central output channel being connected to the module for generating droplets.

Preferably, the at least two output channels connected to separate means for controlling and varying the flow, are the two outer output channels. Preferably, means for controlling and varying the flow are separate aspirating pumps.

Optionally, at least one inlet channel is in fluid communication with and downstream of a serial dilution microfluidic network comprising a plurality of channels having a plurality of intersections.

Preferably, the module for generating droplets is a hydrodynamic flow-focussing module.

The microfluidic system of the invention may further comprise at least one additional inlet channel downstream of the module for generating variable concentrations and connected to the output channel of said module, and upstream of the module for generating droplets. It may also further comprise at least one additional inlet channel downstream of the module for generating droplets.

The microfluidic system of the invention may further comprise (i) a delay line downstream of the module for generating droplets and/or (ii) a second droplet generation module and/or an emulsion re-injection module connected to the output stream of the first module for generating droplets and/or (iii) a droplet fusion module in fluid communication and downstream of the first and second modules for generating droplets or re-injecting emulsions and/or (iv) means for measuring optical signals, preferably for measuring fluorescence.

### BRIEF DESCRIPTION OF THE DRAWINGS

FIG. 1: The three schemes for producing solute streams with variable concentrations of the solute. FIG. 1A: Gaussian concentration profile generated by Taylor dispersion of a solute pulse in a steam of solvent flowing under laminar conditions. The parabolic flow profile in the channel causes the solute pulse to distort into a crescent moon shape; over time, the pulse diffuses into a Gaussian concentration profile. FIG. 1B: Dynamic concentration control on-chip. The front between two miscible phases is scanned over the mouth of the output stream by adjusting the relative flow rates of the two aspirating pumps; the concentration of solute in the output stream varies accordingly. FIG. 1C: Dynamic concentration control on-chip with an upstream serial dilution network. As in FIG. 1B, the concentration of solute in the output stream is varied by modulating the relative flow rates of the two aspirating pumps. However, in this case the diluted streams from a serial dilution network are combined to create four parallel miscible phases and linear ramping of the aspirating pump flow rates results in non-linear ramping of the solute concentration in the output stream.

FIG. 2: Schematic of a microfluidic device for varying the concentration of a solute in a series of microdroplets via Taylor dispersion. A pulse of solute travels along a capillary from the autosampler (‘AS’) and disperses into a Gaussian concentration profile due to Taylor dispersion. The flow from the capillary is combined with substrate and enzyme on-chip and is segmented into droplets by the oil phase. A laser spot for fluorescence measurements is positioned at either the channel just after droplet production or the outlet channel after on-chip incubation. The inset region shows an enlargement of the droplet production area with the nozzle visible.

FIG. 3: A plot of fluorescence intensity against time in the segmented flow from an HPLC autosampler. Taylor dispersion caused the pulse of sodium fluorescein to diffuse at both ends of the pulse, creating droplets with different concentrations of the fluorophore. Measured fluorescence intensity covered a 2 log step range

FIG. 4: Schematic of a microfluidic device for varying the concentration of a solute in a series of microdroplets via on-chip ramping. A microfluidic serial dilution network creates logarithmic dilution streams and combines them into a dilution gradient, which feeds into the scanning chamber. Two aspirating pumps scan the dilution gradient across the mouth of the output stream and enzyme and substrate are added to create a three-way co-flow. Next, the co-flow is segmented into droplets by the oil phase. A laser spot for fluorescence measurements is positioned at either the channel just after droplet production or the outlet channel after on-chip incubation.

FIG. 5: A plot of fluorescence intensity against time in the segmented flow from the on-chip dilution system. The serial dilution network and flow rate ramping created variable sodium fluorescein concentration in the droplets. Measured fluorescence intensity covered a 3 log step range.

FIG. 6: A plot of assay signal against PETG (the inhibitor) concentration for ˜10⁵ microdroplets. As the inhibitor concentration increases, the assay signal (reaction rate) decreases. Fitting the 4-parameter log-logistic curve to these points reveals an IC₅₀ value of 3.04 μM for the inhibitor under the conditions used.

FIG. 7: A plot of assay signal against PETG (the inhibitor) concentration for ˜10⁵ microdroplets. As the inhibitor concentration increases, the assay signal (reaction rate) decreases. Fitting the 4-parameter log-logistic curve to these points reveals an IC₅₀ value of 3.04 μM for the inhibitor under the conditions used.

FIG. 8: A plot of assay signal against RBG (substrate) concentration for ˜10⁵ microdroplets. As the substrate concentration increases, the assay signal (reaction rate) increases. Fitting the Michaelis-Menten curve to these points reveals a K_{M} value of 446.31 μM for the substrate.

FIG. 9: Optical setup for observing the microfluidic device and measuring the green and NIR fluorescence of droplets.

FIG. 10: The microfluidic screening system. (A) Overview of the system. FPGA is an acronym for field-programmable gate array, a high-speed data-acquisition and control system. (B) Design of the microfluidic device (plan view) showing the two depths of channel: 25 μm and 75 μm. Light micrographs of the droplet production region of the device (C) and one of the 10 analysis points (D) with a triangular droplet-respacing feature. The scale bars in both micrographs are equal to 100 μm. (E) Schematic showing the creation of a Gaussian-like pulse of compound in the capillary by Taylor-Aris dispersion, the mixing of this flow with the enzyme and the substrate, and its subsequent segmentation into a stream of droplets. Each droplet contains a different concentration of the compound, but constant concentrations of enzyme and substrate.

FIG. 11: Profile of NIR fluorescence against time for a 1 μl injection of NIR dye. Droplets are plotted as blue dots with their fluorescence values normalized such that the complete profile has an integral of 1. The fitted Taylor-Aris dispersion model is shown as a black line with the fitted values and the actual values (bracketed) shown inset. The full profile of the injection is also shown inset.

FIG. 12: Fluorescence profiles measured for an injection of DY-682 in three successive runs. The profiles are normalized to have an integral of 1 for comparison with the model. The profiles are fitted with Eq. 8 using three fit parameters: injection volume (V; ˜1 μl), flow rate (Q; ˜200 μl/hr), and diffusion coefficient (D). Two parameters were fixed: the length (L; 50 cm) and radius (R; 37.5 μm) of the capillary. The results of the fits are shown in FIG. 13.

FIG. 13: Results of fitting the dispersion profiles of six different fluorophores with the Taylor-Aris dispersion model. At least two replicates (“Rep.”) were performed for each fluorophore. The length (L) of the dispersion capillary was 50 cm and its internal radius (R) was 37.5 μm. Each profile was fitted with Eq. 8 by non-linear curve-fitting using three parameters: flow rate (Q; ˜200 μl/hr), the volume of the injection (V; ˜1 μl), noise (N), and the diffusion coefficient (D). B, the fluorescence background, is determined manually and added to Eq. 8 before fitting to define the floor of each profile. The diffusion coefficients obtained from the fits are in agreement with published values (values marked * are from Kapusta, 2010 and those marked † are from Keminer and Peters, 1999).

FIG. 14: Fluorescence profiles measured for an injection of five different green fluorescent dyes with two replicates per dye. From top to bottom, injections of sodium fluorescein (A and B), ATTO 488 (C and D), FD4 (E and F), FD10 (G and H), and FD20 (I and J). The profiles are smoothed over 1 second periods and normalized to have an integral of 1, allowing comparison with the Taylor-Aris dispersion model. Eq. 8 was fitted to the profiles using three fit parameters: injection volume (V; ˜1 μl), flow rate (Q; ˜200 μl/hr), and diffusion coefficient (D). Two parameters were fixed: the length (L; 50 cm) and radius (R; 37.5 μm) of the capillary. The results of the fits are shown in FIG. 13.

FIG. 15: Plot of diffusion coefficient, D, obtained by fitting the fluorescence data with the Taylor-Aris dispersion model, versus molecular weight for a series of fluorescent dyes (FIG. 13). There are at least two replicates for each fluorophore. The black line corresponds to a non-linear fit of the data using a power law: y=ax^{k} where a and k are fitted parameters. Error bars corresponding to ±1 standard deviation are, in all cases, very small and are hidden by the symbols.

FIG. 16: Taylor-Aris dispersion. Starting from an infinitesimally thin solute layer in a circular channel of diameter 2R (A), under flow, the layer is convectively stretched into a parabolic shape (B). On the timescale TD where diffusive effects are sensitive to the tube diameter (τD˜R²/D where D is the diffusion constant of the solute), this layer diffuses into a plug of width dz˜UR²/D, where U is the average flow velocity across the tube in the direction z (C). At larger time-scales this process is repeated several times (N) for each infinitesimal slice of the new plug. The solute thus takes N random steps of size UR²/D for each time step R²/D, causing the stripe to evolve as a Gaussian curve, spreading with an effective diffusivity of (UR)²/D (D).

FIG. 17: Kinetic profiles of enzymatic reactions in the microfluidic device. The squares represent the mean green fluorescence of droplets as a function of incubation time for 5 U/ml β-galactosidase (A) and 5 mg/l PTP1B (B). The circles represent negative controls where enzyme was not added to the droplets. Each point is the average of ˜24,000 droplets and the error bars correspond to ±1 standard deviation. These plots were used to determine suitable incubation times for initial rate data to be measured by single-point analysis, but with at least a 10-fold increase in fluorescence from time=0. The values chosen were 30 seconds for β galactosidase and 210 seconds for PTP1B.

FIG. 18: High-resolution dose-response screening of β-galactosidase inhibition. (A) Scatter plot of percentage inhibition against PETG concentration for a single injection of PETG, as determined by visible and NIR fluorescence measurements, respectively. Data from 9,716 droplets (dots), were binned along the x-axis and averaged, yielding 28 points (squares; error bars correspond to ±1 standard deviation). These points were used to fit the 4-parameter Hill function (black line; fit parameters are shown inset with the 95% confidence interval.). (B) High resolution dose-response curves for injections of PETG from a 96-well microplate at four different concentrations: high (600 μM), medium (120 μM), low (24 μM), and zero (white squares). Percentage inhibition (y-axis of each square; −10 to 110%) is plotted against compound concentration (logged x-axis; 0.5 to 250 μM for high, 0.1 to 50 μM for medium, 20 nM to 10 μM for low). Fitting the data with the 4-parameter Hill function (not shown) reveals very similar IC₅₀ values for all injections at all three concentrations of injected PETG: the mean IC₅₀ values were 1.98 μM (high; CV=4.18%), 2.06 μM (medium; CV=3.55%), and 1.98 μM (low; CV=3.51%).

FIG. 19: Microplate-measured dose-response profiles for PETG, a β-galactosidase inhibitor, and several compounds that affect PTP1B. (A) The effect of PETG on β-galactosidase activity was measured at 8 different concentrations with 10 replicates per concentration. The remaining graphs illustrate effects on PTP1B activity, as a function of concentration, for the control inhibitor sodium suramin (B), the novel inhibitor sodium cefsulodine (C), the novel weak inhibitor methimazole (D), and the novel weak activator diflunisal (E). The black lines in A and C are the fitted 4-parameter Hill function with the fit parameters shown. In the remaining plots the black line merely connects the binned data points. The IC₅₀ and Hill slope values in B were the x value of the crossing point of the line at y=50% and its gradient at that point, respectively. All precisions in this figure are the 95% confidence interval and all error bars correspond to ±1 standard deviation.

FIG. 20: Measuring the IC₅₀ of PETG for β-galactosidase in microplate and in the microfluidic system. The microfluidic data refers to the “medium” injections in FIG. 18. For each set of samples the mean fitted values for the parameters in the 4-parameter Hill function are shown, along with their mean 95% confidence intervals, as generated during the fitting process. The CV for each parameter over n samples is also shown.

FIG. 21: List of the 704 compounds screened against the enzyme PTP1B. 700 of the compounds were successfully screened and four were not analyzed due to injection failures. In the table “MW” is the molecular weight of the compound and “A Log P” is the atomic-based prediction of log P (partition coefficient), a measure of hydrophilicity/hydrophobicity. The measured effect of each compound on PTP1B activity at 50 μM concentration is shown in the last column of the table; positive values indicate inhibition of the enzyme, while negative values indicate activation.

FIG. 22: High-resolution dose-response screening of a 704 chemical library against PTP1B. Of the 704 compounds injected, 700 were successfully analyzed. (A) Histogram of the effects of the library (plus buffer alone, B, and a known inhibitor, C) on PTP1B activity at 50 μM concentration. Some compounds inhibit activity, while others activate the enzyme. High-resolution dose-response profiles of buffer alone (B), the control inhibitor sodium suramin (C), the novel inhibitor sodium cefsulodine (D), the novel weak inhibitor methimazole (E), and the novel weak activator diflunisal (F). The black line in D is the fitted 4-parameter Hill function with the fit parameters shown inset. In the remaining plots the black line merely connects the binned data points. The IC₅₀ and Hill slope values in C were the x value of the crossing point of the line at y=50% and its gradient at that point, respectively. The IC₂₀ and EC₂₀ values in E and F were determined by finding the crossing point of the line at y=+20% and −20%, respectively. All precisions in this figure are the 95% confidence interval.

FIG. 23: Summary of the most active compounds in the PTP1B screen. These compounds either inhibited or activated PTP by at least 20% when the compound concentration was between 0.1 and 50 μM. The EC₂₀ value (IC₂₀ in the case of inhibitors) for each inhibitor was determined from the crossing point of the dose-response profile at inhibition=−20% (for inhibitors) or inhibition=+20% (for activators). The dose-response profile for sodium cefsulodine was successfully fitted with the 4-parameter Hill function, so an IC₅₀ value is shown for this compound.

FIG. 24: Accuracy and stability tests. (a) Different dilutions were adjusted by shifting the gradient. The resulting measured concentrations were recorded over at least 60 s. (b) The measured concentrations follow the predicted logarithmic behavior, depending on the gradient shift. (c) Dynamic response to a step-function input. A switch over the full dilution range typically needs between 6 to 8 s.

FIG. 25: (a) Timeline showing the precision and reproducibility of a saw-tooth ramping function. (b) Histogram showing the droplet counts at each concentration. The whole dilution range is covered uniformly; no over- or under-sampling is observed. At the lowest concentrations, the signal reaches the detection noise level. (c) Graph demonstrating that any desired concentration function can be generated in time. This particular sequence writes the word ‘WIN’ over the full dilution range.

### DETAILED DESCRIPTION OF THE INVENTION

Generating Concentration Gradients

Concentration gradients for measuring dose-response relationships in microdroplets can be generated using any one of three different methods:

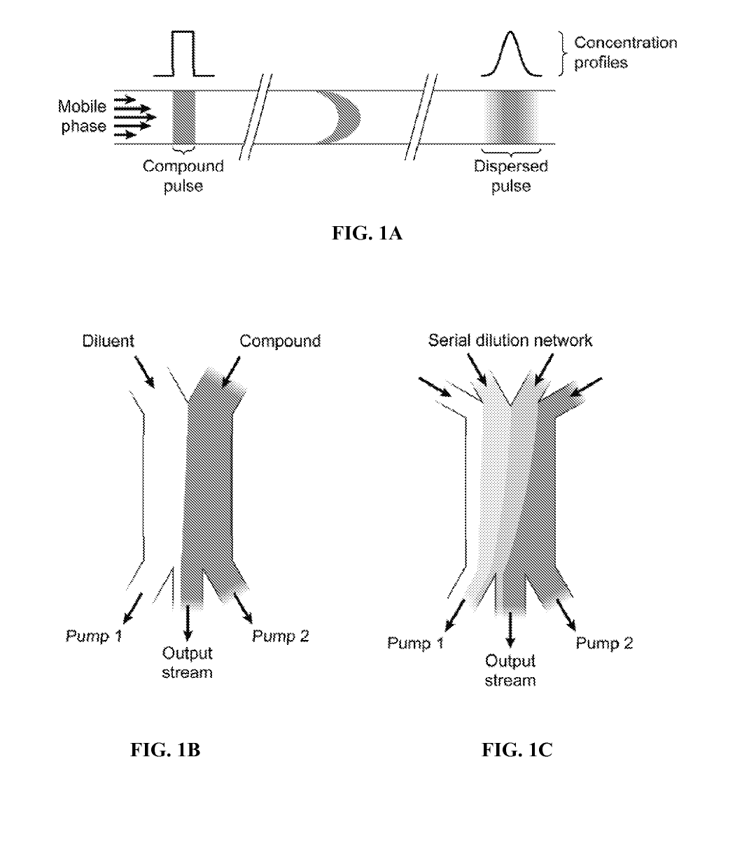

Scheme 1. Introducing a pulse of solute to a stream of solvent flowing along a capillary in a laminar manner. As the pulse travels along the capillary it disperses into the solvent at each end due to Taylor dispersion (Taylor, 1953). This creates two solute concentration gradients: low-to-high and then high-to-low (FIG. 1A). By modulating the length and internal diameter of the capillary and/or the velocity of the solvent stream, it is possible to change the concentration profile of the solute pulse.

Scheme 2. Separate streams of a solvent containing the solute at high concentration and the diluent are pumped into a microfluidic device and combined in a wide channel: the ‘scanning chamber’. The laminar flow of the combined stream causes the front between the two streams to persist for the length of the chamber. The end of the chamber is split into three branches: two outer branches that connect to separate aspirating pumps and a central branch that constitutes the output stream. The flow rate through two of the three channels is actively controlled, e.g. by valves or aspirating syringe pumps. By varying the relative flow rates of the two aspirating pumps it is possible to shift or ‘scan’ the front between the solute and diluent streams across the mouth of the output branch: this causes the concentration of solute in the output stream to vary (FIG. 1B). By modulating the scanning rate and/or the shape of the ramp, it is possible to change the solute concentration profile (over time) in the output stream.

Scheme 3. Dilution scheme 2 can be extended by adding a microfluidic serial dilution network (Jiang et al., 2003) upstream of the scanning chamber. The network creates various dilutions of a source stream in a diluent stream by splitting, mixing, and joining the streams in a network of microfluidic channels. The multiple diluted streams are recombined in the scanning chamber so that a concentration profile is observed across the width of the chamber. As a result, ramping the relative flow rates of the two aspirating pumps in a linear fashion causes the solute concentration in the output stream to vary in a non-linear fashion (FIG. 1C). The profile of solute concentration can be changed by modifying the dilution network upstream of the scanning chamber and/or by modulating the parameters listed for dilution scheme 2.

Segmenting the Solute Stream

After creating the variable concentration stream, it is combined with an oil stream inside a microfluidic device. The solvent stream segments into microdroplets due to capillary instabilities in the two-phase flow (Anna et al., 2003). As the concentration of solute in the solute stream varies, the concentration in each microdroplet varies accordingly.

Monitoring Solute Concentration

Adding a fluorophore, e.g. sodium fluorescein, to the solute before it is diluted allows the concentration of solute at any downstream point to be inferred by the fluorescence intensity of the fluorophore.

Investigating Concentration-Dependent Relationships

Adding an enzyme, cell(s), or other biological material to the microdroplets allows the concentration-dependent effects of the solute to be investigated. This can be achieved by monitoring the effect of the solute on the biological material as a function of the fluorescence of the concentration encoder and, by inference, the concentration of solute.

### DEFINITIONS

As used herein, the term “microfluidic device” or “microfluidic system” refers to a device, apparatus or system including at least one microfluidic channel.

As used herein, the term “microfluidic channel”, “capillary” or “capillary channel” refers to a channel having a cross-sectional dimension of less than 1 mm, and a ratio of length to largest cross-sectional dimension of at least 2:1.

A “channel” as used herein, means a feature on or in an article (e.g., a substrate) that at least partially directs the flow of a fluid. The channel can have any cross-sectional shape (circular, oval, triangular, irregular, square or rectangular, or the like) and can be, partially or entirely, covered or uncovered. Typically, the channel may have a ratio of length to average cross sectional dimension of at least 2:1, more typically at least 3:1, 5:1, 10:1 or more. The channel may be of any size, for example, having a largest dimension perpendicular to fluid flow of less than about 10 mm, 1 mm, 500 μm, 200 μm, 100 μm, 50 μm, 25 μm, 10 μm, 1 μm, 500 nm, 100 nm, 50 nm or 10 nm.

As used herein, the term “cross-sectional dimension” of a channel is measured perpendicular to the direction of fluid flow.

As used herein, the term “droplet” or “microdroplet” refers to an isolated portion of an aqueous phase that is completely surrounded by an oil phase. A droplet may be spherical or of other shapes depending on the external environment. The term “microdroplet” refers to a droplet of less than 1 μL, typically of less than 1 nL, more typically of less than 500 pL. For instance, a microdroplet may have a volume ranging from 10 to 500 pL, preferably from 20 to 250 pL, and more preferably from 50 to 200 pL.

As used herein, the term “upstream” refers to components or modules in the direction opposite to the flow of fluids from a given reference point in a microfluidic system.

As used herein, the term “downstream” refers to components or modules in the direction of the flow of fluids from a given reference point in a microfluidic system.

As used herein, the term “delay line” refers to one or more microfluidic channels in a device wherein droplets are incubated in order to allow a chemical, biochemical, or enzymatic reaction to proceed.

As used herein, the term “solute” refers to any chemical or biological compound which can be dissolved in the solvent. Examples of solutes include, but are not limited to, nucleic acids, peptides, proteins (e.g. enzymes, antibodies), chemical compounds of low molecular weight, enzyme substrates, enzyme inhibitors, receptor ligands, agonists and antagonists, and fluorophore compounds. Chemical compounds of low molecular weight are, for example of molecular mass less than about 1000 Daltons, such as less than 800, 600, 500, 400 or 200 Daltons. The solute may be from a chemical library. Preferred chemical libraries comprise chemical compounds of low molecular weight and potential therapeutic agents.

As used herein, the term “solvent” refers to a liquid in which the solute can be dissolved to form a solution. Examples of solvents include, but are not limited to, water and other aqueous solutions, and organic solutions such as ethanol, methanol, acetonitrile, dimethylformamide, and dimethylsulfoxide.

As used herein, the term “at least two component system” refers to any combination of two or more components which interact or could interact the ones with the others. Examples of at least two component systems include, but are not limited to, enzyme/substrate, enzyme/substrate/inhibitor, enzyme/substrate/activator, enzyme/substrate/cofactor, cell receptor/agonist, and cell receptor/agonist/antagonist, antibody/antigen, nucleic acid binding protein/nucleic acid, cell/compound modulating, activating or inhibiting, a function of the cell, microbial cell/antibiotic, fungal cell/antifungal compound, tumoral cell/antitumoral compound.

As used herein, the term “about” refers to a range of values ±10% of the specified value. For example, “about 20” includes ±10% of 20, or from 18 to 22. Preferably, the term “about” refers to a range of values ±5% of the specified value.

The present invention concerns a method for generating variable concentrations of a solute in microdroplets. The method of the invention allows the generation of a population of microdroplets in which the concentration of the solute can vary on a range of at least 2 orders of magnitude, preferably at least 3 orders of magnitude, with very small steps in concentration.

In a first embodiment, the method of the invention comprises

(a) flowing a solvent into a microfluidic channel in a laminar manner;

(b) introducing a pulse of a solute to the stream of solvent;

(c) flowing the stream containing the solvent and the solute along the channel; and

(d) generating microdroplets by combining the output stream of the channel with an oil phase, said microdroplets containing variable concentration of the solute.

The principle of this embodiment is illustrated in FIG. 1A.

The microfluidic channel used in the method of the invention has an internal diameter less than 1 mm, preferably less than 500 μm. In particular, the micro fluidic channel may have an internal diameter ranging from 500 μm to 20 μm, preferably from 100 μm to 25 μm, more preferably from 100 μm to 50 μm.

The micro fluidic channel used in the method of the invention has a length greater than 1 cm, preferably greater than 25 cm. In particular, the microfluidic channel may have a length ranging from 1 cm to more than 1 m, preferably from 1 cm to 1 m, more preferably from 10 cm to 75 cm, and even more preferably from 25 cm to 75 cm.

The flow rate of the solvent and the configuration of the microfluidic channel have to be selected in order to obtain a laminar flow of solvent along the channel. The Reynolds number is a dimensionless number that may be used to characterize different flow regimes, such as laminar or turbulent flow: laminar flow occurs at low Reynolds numbers, while turbulent flow occurs at high Reynolds numbers. Increasing the fluid velocity, increasing the kinematic viscosity of the fluid, or decreasing the dimensions of the channel increases the Reynolds number. The Reynolds number can be easily calculated by the skilled person. Preferably, the Reynolds number is lower than about 2,300 in order to obtain a laminar flow along the channel.

In step (b) of the method, a pulse of solute is introduced in the laminar stream of the solvent. Typically, the volume of this pulse ranges from 1 μl to 5 μl, preferably from 1 μl to 2 μl. In a preferred embodiment, the volume of the pulse of solute is 1 μl. This pulse may be injected manually or automatically, for example using an autosampler.

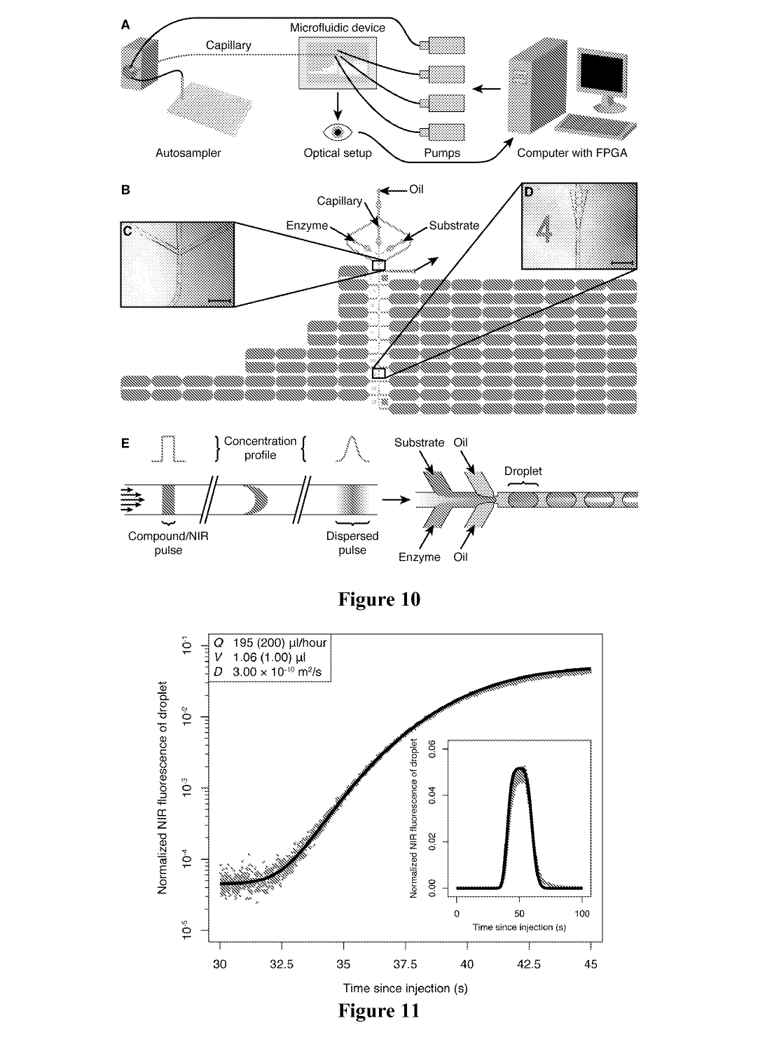

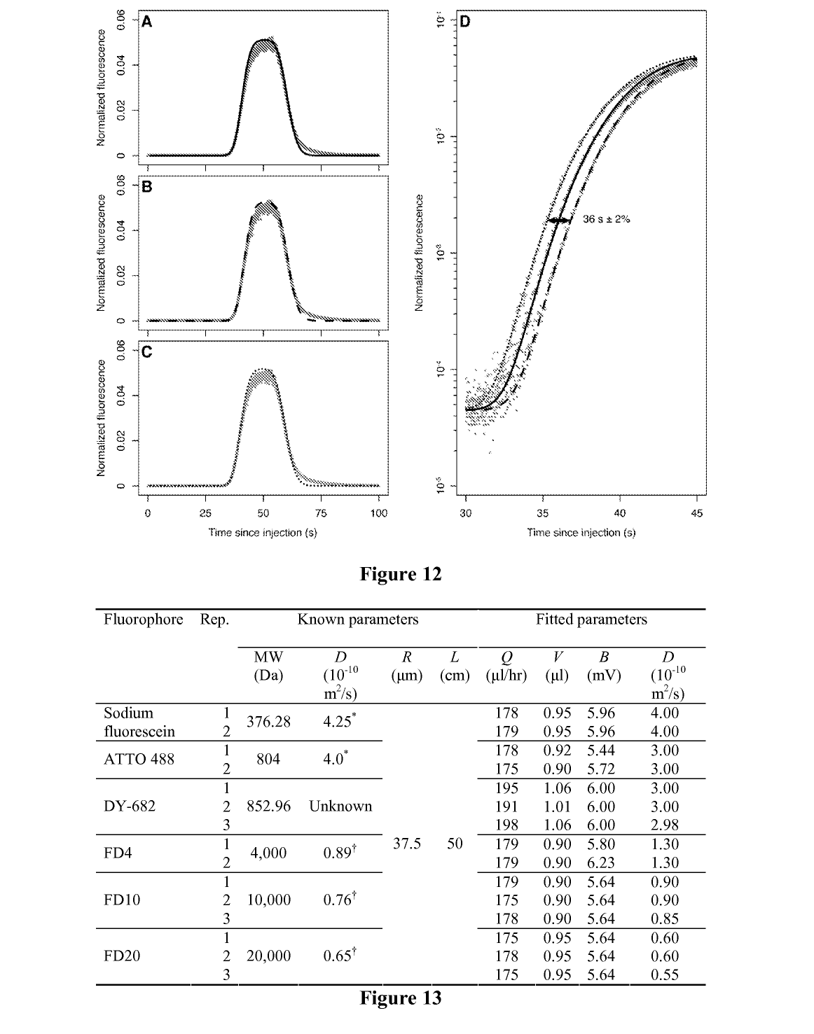

In step (c) of the method, the pulse of solute travels along the channel in the flow stream containing the solvent. In a preferred embodiment, during this travel, the solute disperses into the solvent due to Taylor-Aris dispersion. The theoretical framework of Taylor-Aris dispersion is briefly reminded in the experimental section. As illustrated in FIG. 10E, left drawing, due to Taylor-Aris dispersion, the rectangular concentration profile of the pulse of solute is transformed during its travel along the channel into a Gaussian-like pulse. This Gaussian-like profile provides two solute concentration gradients: low-to-high and high-to-low, as illustrated for example in FIGS. 3 and 12. By modulating the length, the internal diameter of the channel and/or the flow rate of solvent, the person skilled in the art may easily modify the concentration profile of the pulse of solute at the end of the microfluidic channel. For example, if the length of the microfluidic channel increases, or the internal diameter of the channel increases, or the flow rate of the solvent decreases, the absolute values of the slopes of the concentration profile decrease.

The concentration profile of a solute at the end of the microfluidic channel may be calculated based on the equation below representing the concentration of the solute (C) at a fixed point (Lₘ) in the microfluidic channel as a function of time (t).

$$C ( {L}_{m} , t ) = \frac{{C}_{0}}{2} ( erf \frac{{L}_{m} + {L}_{p} - Ut}{\sqrt{4 {D}_{eff} t}} - erf \frac{{L}_{m} - Ut}{\sqrt{4 {D}_{eff} t}} )$$

where C₀ is the original concentration of the solute in the pulse, erf( ) is the Gauss error function, Lₚ is the original length of the solute pulse in the channel, U is the average velocity of the fluid in the channel and D_{eff} is the diffusion coefficient (or effective diffusion coefficient) of the solute. Consequently, using the theoretical Taylor-Aris dispersion and the diffusion coefficient of the solute, the concentration of the solute in generated microdroplets can be calculated. The diffusion coefficient of the solute can be measured or estimated from the molecular weight of the solute. To measure the diffusion coefficient of the solute, the concentration of the solute can be measured at the end of the microfluidic channel before generating droplets. This concentration may be measured by any technique known by the skilled person such as, for example, refractive index, UV or IR absorption or mass spectroscopy. This time trace is then plotted and represents the concentration of the solute at a fixed point in the channel as a function of time. The equation above is then used to calculate the diffusion coefficient from this plot.

The diffusion coefficient of the solute can also be measured by any known techniques such as dynamic light-scattering (see Holde et al., 2006, section 7.2, herein enclosed by reference) or by measuring diffusion across a porous diaphragm.

The diffusion coefficient of the solute can also be estimated from the molecular weight and the shape of the solute. For example, the diffusion coefficient of a molecule can be calculated using the equation below:

$$D = \frac{RT}{Nf}$$

wherein D is the diffusion coefficient, R is the gas constant, T is the absolute temperature, N is Avogadro number and f is the frictional coefficient.

For a spherical molecule, the frictional coefficient is given by Stokes's law:

f=6πηa

wherein f is the frictional coefficient, a is the radius of the sphere and η is the viscosity of the solvent. Consequently, for a spherical molecule, the diffusion coefficient can be calculated using the equation below:

$$D = \frac{RT}{6 π N η a}$$

wherein D is the diffusion coefficient, R is the gas constant, T is the absolute temperature, N is Avogadro number, η is the viscosity of the solvent and a is the radius of the sphere. For other forms of molecule, it is also possible to calculate the diffusion coefficient using other frictional coefficients (see Holde et al, 2006, section 5.2.2, herein enclosed by reference).

In a second embodiment, the method of the invention comprises

(a) providing a microfluidic system comprising at least two inlet channels that intersect to form a microfluidic channel, said microfluidic channel comprising three output channels, at least two of which are connected to a separate means for controlling and varying the flow, preferably an aspirating pump, the central output channel containing the output stream of the channel, said central output channel being in fluid communication with the module for generating microdroplets;
(b) flowing a first fluid in one inlet channel and an at least one second fluid containing a solute in another inlet channel, the interface formed between the fluids in the micro fluidic channel persisting for the length of the channel;
(c) varying the relative flow rates into the outer output channels;
(d) generating microdroplets by combining the output stream of the central channel with an oil phase, said microdroplets containing variable concentration of the solute.

The micro fluidic system provided in step (a) is illustrated, at least in part, in FIGS. 1B and 1C.

In this embodiment, separate streams of different fluids (a first fluid and at least one second fluid) containing different concentration of solute are introduced in a micro fluidic channel, also named scanning chamber, thought several inlet channels, one inlet channel for each fluid. One of these fluids may comprise no solute at all. These fluids flow along the microfluidic channel in a laminar manner and the fronts between these different fluids persist for its entire length. As described above for the first embodiment of this method, the Reynolds number is preferably lower than about 2,300 in order to obtain a laminar flow along the channel. The end of the scanning chamber is split into three output channels (or branches). The flow rates through at least two of these channels are actively controlled. These output channels are thus connected to separate means for controlling and varying the flow. Preferably, in step (a) of the method the two outer output channels are connected to a separate means for controlling and varying the flow. These means may be aspirating pumps or valves, preferably aspirating pumps. Alternatively, the two outer output channels can be connected to a single common outlet via a common flow control valve which regulates the relative flow rate in each of the two outer output channels. The central output channel contains the output stream of the scanning chamber and is in fluid communication with the module to generate droplets.

Typically, the micro fluidic channel or scanning chamber has a length ranging from 1 μm to 1 cm, preferably from 10 μm to 10 mm, more preferably from 10 μm to 1 mm, and a width ranging from 1 μm to 1 cm, preferably from 10 μm to 1 mm. Preferably, inlet channels and/or output channels are microfluidic channels. More preferably, all inlet and output channels are microfluidic channels.

By varying the relative flow rates in at least two output channels, preferably in the two outer ouput channels, the front (or the fronts if there is more than two different fluids) between the different fluids moves across the width of the scanning chamber. Consequently, the concentration of solute in the output stream of the central output channel varies. The solute concentration profile in the output stream of the scanning chamber may thus vary over time thanks to the modulation of the relative flow rates of two output channels, preferably the two outer output channels.

In this embodiment, step (b) may comprise flowing several second fluids, each of these fluids containing a different concentration of the solute. Each of these fluids is introduced in the micro fluidic channel, or scanning chamber, through a separate inlet channel. These second fluids may be provided by a microfluidic serial dilution network, such as described in the article of Jiang et al., 2003, which is upstream of the scanning chamber. This network creates various dilutions of a solute stream in a solvent stream by splitting, mixing, and joining the streams in a network of microfluidic channels. The multiple fluids cause multiple fronts which persist for the entire length of the scanning chamber. As a result, ramping the relative flow rates in two output channels, preferably the two outer output channels, in a linear fashion causes the solute concentration on the output stream of the central channel to vary in a non-linear fashion. In this embodiment, the profile of solute concentration in the output stream of the central channel may vary over time thanks to the modulation of the relative flow rates of two output channels, preferably the two outer output channels, and/or thanks to the modification of parameters of the microfluidic serial dilution network.

In step (d) of the method of the invention, microdroplets are generated by combining the output stream of the channel with an oil phase.

In the first embodiment described above, generated microdroplets contain variable concentration of the solute due to the Gaussian-like profile of the solute concentration obtained at the end of the microfluidic channel.

In the second embodiment described above, generated microdroplets contain variable concentration of the solute due to the particular profile of solute concentration in the output stream of the central channel.

The size of steps in solute concentration in the population of droplets relies on the droplet production rate. If the production rate increases, the population of droplets comprises a greater variability in solute concentration and thus the steps in concentration are smaller. On contrary, if the production rate decreases the steps in concentration increase.

Typically, microdroplets are produced at relatively high frequencies. For example, the droplets may be formed at frequencies between 1 and 10,000 droplets per second, preferably between 100 and 2,000 droplets per second.

Microdroplets may be produced by any technique known by the skilled person to generated droplets on microfluidic devices such as drop-breakoff in co-flowing streams, cross-flowing streams in a T-shaped junction, and hydrodynamic flow-focussing (reviewed by Christopher and Anna, 2007). Preferably, the water-in-oil emulsion generated is a monodispersed emulsion, i.e. an emulsion comprising droplets of the same volume. Preferably, microdroplets are generated by hydrodynamic flow-focussing.

The oil phase used to generate the microdroplets may be selected from the group consisting of fluorinated oil such as FC40 oil (3M®), FC43 (3M®), FC77 oil (3M®), FC72 (3M®), FC84 (3M®), FC70 (3M®), HFE-7500 (3M®), HFE-7100 (3M®), perfluorohexane, perfluorooctane, perfluorodecane, Galden-HT135 oil (Solvay Solexis), Galden-HT170 oil (Solvay Solexis), Galden-HT110 oil (Solvay Solexis), Galden-HT90 oil (Solvay Solexis), Galden-HT70 oil (Solvay Solexis), Galden PFPE liquids, Galden® SV Fluids or H-Galden®ZV Fluids; and hydrocarbon oils such as Mineral oils, Light mineral oil, Adepsine oil, Albolene, Cable oil, Baby Oil, Drakeol, Electrical Insulating Oil, Heat-treating oil, Hydraulic oil, Lignite oil, Liquid paraffin, Mineral Seal Oil, Paraffin oil, Petroleum, Technical oil, White oil, Silicone oils or Vegetable oils. Preferably, the oil phase is fluorinated oil such as FC40 oil, Galden-HT135 oil, HFE-7500 or FC77 oil. The skilled person may easily choose suitable phase oil according to the application of the method of the invention.

Typically the oil phase also comprises one or several surfactants. Said surfactant may be selected from the group consisting of EA-surfactant (RainDance Technologies) and DMP (dimorpholino phosphate)-surfactant (Baret, Kleinschmidt, et al., 2009), the polymeric silicon-based surfactant Abil EM 90, Span 80, Triton X-100 and Krytox (DuPont). The skilled person may easily choose a suitable surfactant if necessary according to the application of the method of the invention.

The method of the invention may further comprises after step (c) and before or after step (d), the step (c′) of combining the output stream of the microfluidic channel with one or several additional fluids. According to the first or the second embodiment of the method of the invention, one or several additional fluids may be combined with the output stream of the micro fluidic channel used to generate a particular profile of solute concentration and being in fluid communication with the module to generate droplets. This combination may be carried out before or after droplet generation. In an embodiment, one or several additional fluids are combined with the output stream of the microfluidic channel before generating microdroplets. In this case, droplets generated in step (d) comprise the solute/solvent or first fluid/second fluid(s) mix combined with one or several additional fluids. In another embodiment, one or several additional fluids are combined with the output stream of the microfluidic channel after generating microdroplets. In this case, the method further comprises after step (d), the step (d′) of adding one or more additional fluids to droplets previously generated in step (d). In one embodiment, said one or several additional fluids are combined with the generated microdroplets by merging a stream of an additional fluid with droplets previously generated in step (d) as the droplets pass an orifice from which the additional fluid exits (Shestopalov et al., 2004; Li et al., 2007). In a further embodiment, said one or several additional fluids are contained in one or several additional sets of droplets and step (d′) may be achieved by fusing additional droplets with droplets previously generated in step (d). This droplet fusion may be conducted by any technique known by the skilled person such as spontaneous coalescence (Tan et al., 2007; Song et al., 2003; Hung et al., 2006; Niu et al., 2008; Um and Park, 2009; Sassa et al., 2008), coalescence based on a surface energy pattern on the walls of a microfluidic device (Fidalgo et al., 2007; Liu and Ismagilov, 2009), fusion using local heating from a focused laser (Baroud et al., 2007), or using electric forces (electrocoalescence) (Link et al., 2006; Priest et al., 2006; Ahn et al., 2006; Frenz et al., 2008), or by exploiting transient states in the build-up of surfactant molecules at the droplet interface (Mazutis et al., 2009). In a particular embodiment, one or several additional fluids are combined with the output stream of the micro fluidic channel before generating microdroplets and one or several additional fluids are combined with the output stream of the microfluidic channel after generating microdroplets by fusing one or several additional sets of droplets containing one or several additional fluids with droplets generated in step (d) or by merging streams of additional fluids with droplets generated in step (d), as described above. If several droplets have to be fused to form a single droplet, fusion events may occur concurrently or separately. If several additional fluids have to be combined with droplets generated in step (d), streams of these additional fluids may be merged with droplets concurrently or separately. Preferably, additional fluids are hydrophilic fluids, such as aqueous solution, and comprise one of several components. These components may be soluble or insoluble in the solvent of said fluid. Examples of such component include, but are not limited to, peptide, protein, antibody, enzyme, enzyme substrate, compound modulating the activity of an enzyme such as enzyme inhibitor or activator, prokaryote, eukaryote or archaea cell and cell receptor, nucleic acid or fluorophore compound.

In an embodiment, the method of the invention further comprises, before introducing the solute in the microfluidic device, i.e. before step (a), the step of mixing said solute with a reporter molecule, preferably a dye, more preferably a fluorescent dye. Examples of fluorescent dyes include, but are not limited to, ATTO488 (Sigma-Aldrich Co, Missouri, USA), BODIPY FL (Invitrogen Corp. California, USA), DyLight 488 (Pierce Biotechnology, Inc. Illinois, USA), Sodium fluorescein, DY-682 (Dyomics GmbH, Jena, Germany), green fluorescent protein (GFP) and derivatives such as EGFP, blue fluorescent proteins (EBFP, EBFP2, Azurite, mKalama1), cyan fluorescent proteins (ECFP, Cerulean, CyPet) and yellow fluorescent proteins (YFP, Citrine, Venus, YPet), DsRed and derivatives thereof, Keima and derivatives thereof. In particular, the fluorescent dye may be selected from the group consisting of ATTO488, BODIPY FL, DyLight 488, Sodium fluorescein and DY-682. In a particular embodiment, the fluorescent dye is a far-red (FR) or near-infrared (NIR) fluorescent dye. Examples of far-red or near-infrared fluorescent dyes include, but are not limited to, FR and NIR fluorescent DyLight dyes such as DyLight 680, DyLight 682, DyLight 750 or DyLight 800, FR and NIR fluorescent Alexa Fluor dyes such as Alexa Fluor 647, Alexa Fluor 680 or Alexa Fluor 750, and FR and NIR fluorescent Cyanine dyes such as Cy5, Cy5.5 or Cy7.

Preferably, the reporter molecule is chosen to have a molecular weight which is substantially equivalent to the molecular weight of the solute. In this case, the concentration profile of the solute in microdroplets may be estimated by measuring the concentration profile of the reporter molecule in microdroplets. Optionally, estimating the concentration profile of the solute from the concentration profile of the reporter molecule in microdroplets comprises an additional step of correcting the profile by taking into account the difference between the dispersion coefficients of the solute and the reporter molecule. For example, the concentration of the solute inside the droplet can be determined from the fluorescence of a co-injected fluorescent dye in an indirect manner. The different diffusion coefficients of the solute and the dye cause them to disperse differently. By estimating or determining the diffusion coefficients of both species, it is possible to reconstruct their superimposed dispersion profiles in the output stream of the channel. If the concentration of fluorescent dye inside a droplet is known, then it is possible to calculate the concentration of the co-injected solute at the point in time when the droplet was formed. In this way, solute concentration can be inferred from the fluorescence of a co-injected fluorescent dye, even when the diffusion coefficients of the two species are different.

The method of the invention for generating variable concentration of a solute in microdroplets allows the generation of extremely precise dose-response curves containing very large numbers of data points, up to 20,000 data points, over a continuous concentration range.

Accordingly, in another aspect, the present invention concerns a method for determining a dose-response relationship in an at least two component system, said method comprising (1) generating variable concentration of a solute in microdroplets with the method of the invention as described above, wherein the output stream of the microfluidic channel is combined with one or several additional fluids and wherein the solute is a first component of the at least two component system and one additional fluid contains a second component of the system; and (2) measuring the response of the at least two component system in each microdroplet.

In an embodiment, the method for determining a dose-response relationship in an at least two component system comprises

(i) flowing a solvent into a micro fluidic channel in a laminar manner;

(ii) introducing a pulse of a first component of said system to the stream of solvent;

(iii) flowing the stream containing the solvent and the first component of said system along the channel;

(iv) combining the output stream of the channel with one or several additional fluids, one additional fluid containing a second component of said system;

(v) generating microdroplets by combining the mix of the output stream of the channel and said additional fluids with an oil phase, said microdroplets containing variable concentration of the first component of said system and one or several additional fluids, one additional fluid containing a second component of said system; and

(vi) measuring the response of said system in each microdroplet.

In another embodiment, the method for determining a dose-response relationship in an at least two component system comprises

(i) flowing a solvent into a micro fluidic channel in a laminar manner;

(ii) introducing a pulse of a first component of said system to the stream of solvent;

(iii) flowing the stream containing the solvent and the first component of said system along the channel;

(iv) generating microdroplets by combining the output stream of the channel with an oil phase;

(v) providing one or several additional set of microdroplets containing one or several additional fluids, one additional fluid containing a second component of said system;

(vi) fusing microdroplets provided in step (v) with microdroplets generated in step (iv), fused microdroplets containing variable concentration of the first component of said system and one or several additional fluids, one additional fluid containing a second component of said system; and

(vii) measuring the response of said system in each microdroplet.

In another embodiment, the method for determining a dose-response relationship in an at least two component system comprises

(i) flowing a solvent into a micro fluidic channel in a laminar manner;

(ii) introducing a pulse of a first component of said system to the stream of solvent;

(iii) flowing the stream containing the solvent and the first component of said system along the channel;

(iv) generating microdroplets by combining the output stream of the channel with an oil phase;

(v) merging microdroplets generated in step (iv) with stream(s) of one or several additional fluids thereby obtaining microdroplets containing variable concentration of the first component of said system and one or several additional fluids, one additional fluid containing a second component of said system; and

(vii) measuring the response of said system in each microdroplet.

In another embodiment, the method for determining a dose-response relationship in an at least two component system comprises

(i) providing a micro fluidic system comprising at least two inlet channels that intersect to form a microfluidic channel, said microfluidic channel comprising three output channels, at least two of which, preferably the two outer output channels, are connected to a separate means for controlling and varying the flow, the central output channel containing the output stream of the channel, said central output channel being in fluid communication with the module for generating microdroplets;

(ii) flowing a first fluid in one inlet channel and an at least one second fluid containing a first component of said system in another inlet channel, the interface formed between the fluids in the microfluidic channel persisting for the length of the channel;

(iii) varying the relative flow rates into the at least two output channels, preferably the two outer output channels;

(iv) combining the output stream of the central channel with one or several additional fluids, one additional fluid containing a second component of said system;

(v) generating microdroplets by combining the mix of the output stream of the central channel and said additional fluids with an oil phase, said microdroplets containing variable concentration of the first component of said system and one or several additional fluids, one additional fluid containing a second component of said system; and

(vi) measuring the response of said system in each microdroplet.

In a further embodiment, the method for determining a dose-response relationship in an at least two component system comprises

(i) providing a micro fluidic system comprising at least two inlet channels that intersect to form a microfluidic channel, said microfluidic channel comprising three output channels, at least two of which, preferably the two outer output channels, are connected to a separate means for controlling and varying the flow, the central output channel containing the output stream of the channel, said central output channel being in fluid communication with the module for generating microdroplets;

(ii) flowing a first fluid in one inlet channel and an at least one second fluid containing a first component of said system in another inlet channel, the interface formed between the fluids in the microfluidic channel persisting for the length of the channel;

(iii) varying the relative flow rates into the at least two output channels, preferably the two outer output channels;

(iv) generating microdroplets by combining the output stream of the central channel with an oil phase;

(v) providing one or several additional set of microdroplets containing one or several additional fluids, one additional fluid containing a second component of said system;

(vi) fusing microdroplets provided in step (v) with microdroplets generated in step (iv), fused microdroplets containing variable concentration of the first component of said system and one or several additional fluids, one additional fluid containing a second component of said system; and

(vii) measuring the response of said system in each microdroplet.

In a further embodiment, the method for determining a dose-response relationship in an at least two component system comprises

(i) providing a micro fluidic system comprising at least two inlet channels that intersect to form a microfluidic channel, said microfluidic channel comprising three output channels, at least two of which, preferably the two outer output channels, are connected to a separate means for controlling and varying the flow, the central output channel containing the output stream of the channel, said central output channel being in fluid communication with the module for generating microdroplets;

(ii) flowing a first fluid in one inlet channel and an at least one second fluid containing a first component of said system in another inlet channel, the interface formed between the fluids in the microfluidic channel persisting for the length of the channel;

(iii) varying the relative flow rates into the at least two output channels, preferably the two outer output channels;

(iv) generating microdroplets by combining the output stream of the central channel with an oil phase;

(v) merging microdroplets generated in step (iv) with stream(s) of one or several additional fluids thereby obtaining microdroplets containing variable concentration of the first component of said system and one or several additional fluids, one additional fluid containing a second component of said system; and

(vii) measuring the response of said system in each microdroplet.

The second component of the at least two component system may be for example proteins, enzymes, antibodies, protein complexes, archaea, prokaryote or eukaryote cells or cell receptors, or nucleic acids. In an embodiment, the second component is an enzyme. In another embodiment, the second component is a cell.

The first component of the at least two component system may be for example peptides, proteins, antibodies, enzyme substrates, enzyme inhibitors, enzyme activators, enzyme cofactors, agonists, antagonists or ligands of a receptor, nucleic acids, chemical compounds of low molecular weight, antibiotics, antifungal compounds or antitumoral agents.

In a particular embodiment, the system comprises two components, the second component being a target molecule and the first component being a ligand of said target molecule. Examples of target molecules include, but are not limited to, a peptide, a protein, an enzyme, an antibody, a receptor, a nucleic acid and a cell. Examples of ligand of the target molecule include, but are not limited to, a enzyme substrate, an enzyme inhibitor, an enzyme cofactor, an antigen, a ligand receptor, a nucleic acid binding protein.

In another particular embodiment, the system comprises two components, the second component being an enzyme and the first component being a substrate of said enzyme.

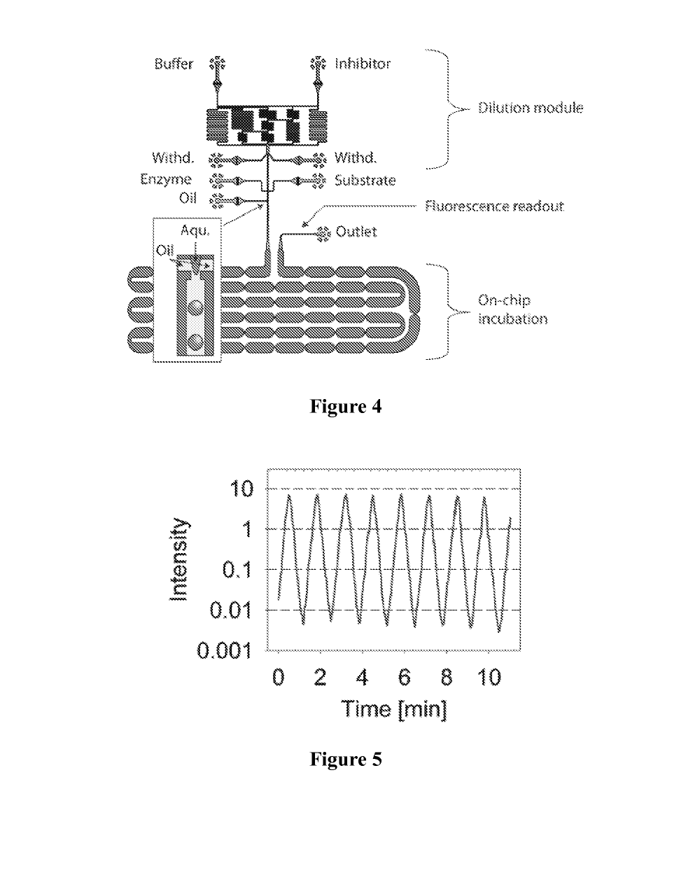

In another particular embodiment, the system comprises three components, the second component being an enzyme, the first component being an inhibitor of said enzyme and the third component being a substrate of said enzyme. Such an embodiment is illustrated in FIG. 4.

In a further embodiment, the system comprises three components, the second component being an enzyme, the first component being an activator of said enzyme and the third component being a substrate of said enzyme.

Preferably, enzyme substrates used in the method of the invention are fluorogenic substrates. There is a great variety of fluorogenic substrates commercially available and the skilled person can easily choose a suitable substrate according to the enzymatic activity to be detected. Examples of fluorogenic substrates include, but are not limited to, Fluorescein-di-beta-D-galactopyranoside (FDG), Fluorescein diphosphate (FDP) or resorufin β-D-galactopyranoside (RBG).

In another particular embodiment, the system comprises two components, the second component being a single cell or multiple cells and the first component being a agonist of a function of said single cell or multiple cells. The agonist can induce an activity which is then detected in the cell, for example by measuring fluorescence. Any fluorogenic cell based assays known by the skilled person can be used in the method of the invention. For instance, changes in intracellular calcium signal induced by the agonist can be detected by pre-loading the cells with a calcium sensitive fluorophore. In another particular embodiment, the system comprises three components, the second component being a single cell or multiple cells, the first component being an antagonist of a function of said cells and the third component being an agonist of a function of said cells.

In embodiments wherein the system comprises more than two components, additional components, i.e. third, fourth, etc. . . . , are provided in additional fluids as described above. Preferably, components are provided in separate additional fluids.

Optionally, one or several additional fluids comprise additional reagents required for obtaining the response of the system. Examples of these reagents include, but are not limited to, enzyme cofactors, ATP, GTP and enzyme substrate. These reagents may be comprised in the same additional fluid than the second component of the system or in another additional fluid. These reagents may be easily identified by the skilled person according to the multi-component system used in this method.

In an embodiment, the response of the system is measured by quantifying an optical signal. Typically, the optical signal is emitted by the product of the reaction between the components of the system. Preferably, the optical signal is absorbance, luminescence, fluorescence, fluorescence polarization or time-resolved fluorescence. More preferably, the optical signal is a fluorescent signal. In a particular embodiment, the two component system comprises an enzyme and its substrate and the optical signal is emitted by the product of the enzymatic reaction

In an embodiment, the method further comprises (3) plotting the response of the at least two component system in each microdroplet.

In a particular embodiment, the system comprises two components, the second component being an enzyme and the first component being a substrate of said enzyme, and the method further comprises after step (3) the step (4) of determining the Michaelis and/or Vₘₐₓ constants of said system. The Michaelis constant, or K_{M}, is equal to the substrate concentration in an enzyme substrate reaction at which the reaction rate is equal to half of its maximal value (Vₘₐₓ).

In another embodiment, the system comprises three components, the second component being an enzyme, the first component being a modulator, inhibitor or activator, of said enzyme and the third component being a substrate of said enzyme. In this case, the profile of the curve obtained in step (3) and characterizing the response could generate very useful information on the activity of the modulator. This profile may be sufficient to show if the modulator is an inhibitor or an activator. The profile may also provide information of the dose-response relationship between the enzyme activity and said modulator. Indeed, the curve may show, for example, that the modulator is an activator at low doses and an inhibitor at high doses. The method of the invention thus allows to identify complex relationship such as partial agonism or antagonism. After step (3), the method may further comprise step (4) of determining an effective or inhibitory concentration value of the modulator in said system. In an embodiment, step (4) comprises determining an effective concentration value of the activator in said system. Preferably the effective concentration is selected from the group consisting of EC₂₀, EC₅₀ and EC₉₀. In another embodiment, step (4) comprises determining an inhibitory concentration value of the inhibitor in said system. Preferably the inhibitory concentration is selected from the group consisting of IC₂₀, IC₅₀ and IC₉₀.

In an embodiment, the concentration of the first component of the system in microdroplets may be measured by assessing the concentration of a reporter molecule mixed with said component. Preferably, the reporter molecule is a fluorescent dye, in particular a far-red or near-infrared fluorescent dye. Examples of such dyes have been disclosed above. In a particular embodiment, the methods further comprise step (5) of refining the measured concentration of the first component of the system in microdroplets by taking into account the difference between the diffusion coefficients of said first component and the reporter molecule.

In another embodiment, the concentration of the first component in microdroplets is calculated from the theoretical concentration profile of the first component in the output stream of the channel used to generate variable concentrations, as described above.

In another aspect, the present invention concerns a method for screening, selecting or identifying a compound active on a target component, said method comprising

(1) providing a library of candidate compounds;

(2) generating for each candidate compound provided in step (1) a population of microdroplets with variable concentration of said candidate compound with the method according to the invention for generating variable concentration of a solute in microdroplets, wherein the output stream of the microfluidic channel is combined with one or several additional fluids, wherein the solute is the candidate compound and one additional fluid contains the target component;

(3) measuring the activity of said candidate compounds on the target component in each microdroplet; and

(4) identifying candidate compounds which are active on the target component.

Optionally, one or several additional fluids comprise reagents required for the activity of the candidate compound on the target component. Examples of these reagents include, but are not limited to, enzyme cofactors, ATP, GTP and enzyme substrate. These reagents may be comprised in the same additional fluid than the target component or in another additional fluid. These reagents may be easily identified by the skilled person according to the target component and the compounds to be screened.

The target component may be, for example, nucleic acid, protein (e.g. enzyme, antibody, receptor), protein complex, protein-nucleic acid complex or cell.

The candidate compounds may be any chemical or biological compound. They may be chosen from the group consisting of nucleic acids, peptides, proteins (e.g. enzymes, antibodies), chemical compounds of low molecular weight, enzyme substrates, enzyme inhibitors, enzyme activators, receptor ligands, agonists and antagonists. The candidate compounds may also be from a chemical library. Preferred chemical libraries comprise chemical compounds of low molecular weight and potential therapeutic agents. They may have activating or inhibiting activity on the target component.

In a particular embodiment, the method comprises

(i) providing a library of candidate compounds;

(ii) flowing a solvent into a microfluidic channel in a laminar manner;

(iii) introducing sequentially a pulse of each candidate compound to the stream of solvent, preferably using an autosampler;

(iv) flowing the stream containing the solvent and candidate compounds along the channel;

(v) combining the output stream of the micro fluidic channel with one or several additional fluids, one additional fluid containing the target component;

(v) generating microdroplets by combining the mix of the output stream of the channel and said additional fluids with an oil phase, said microdroplets comprising for each candidate compound a population of microdroplets with variable concentration of said candidate compound and the target component;

(vi) measuring the activity of each candidate compounds on the target component in each microdroplet; and

(vii) identifying candidate compounds which are active on the target component.

In another particular embodiment, the method comprises

(i) providing a library of candidate compounds;

(ii) flowing a solvent into a microfluidic channel in a laminar manner;

(iii) introducing sequentially a pulse of each candidate compound to the stream of solvent;

(iv) flowing the stream containing the solvent and candidate compounds along the channel;

(v) generating microdroplets by combining the output stream of the channel with an oil phase

(vi) providing one or several additional sets of microdroplets containing one or several additional fluids, one additional fluid containing the target component;

(vii) fusing microdroplets providing in step (vi) with microdroplets generated in step (v), fused microdroplets comprising for each candidate compound a population of microdroplets with variable concentration of said candidate compound and the target component;

(viii) measuring the activity of each candidate compounds on the target component in each microdroplet; and

(ix) identifying candidate compounds which are active on the target component.

In another particular embodiment, the method comprises

(i) providing a library of candidate compounds;

(ii) flowing a solvent into a microfluidic channel in a laminar manner;

(iii) introducing sequentially a pulse of each candidate compound to the stream of solvent;

(iv) flowing the stream containing the solvent and candidate compounds along the channel;

(v) generating microdroplets by combining the output stream of the channel with an oil phase;

(vi) merging microdroplets generated in step (v) with stream(s) of one or several additional fluids, one additional fluid containing the target component, thereby obtaining microdroplets comprising for each candidate compound a population of microdroplets with variable concentration of said candidate compound and the target component;

(vii) measuring the activity of each candidate compounds on the target component in each microdroplet; and

(viii) identifying candidate compounds which are active on the target component.

In another particular embodiment, the method comprises

(i) providing a library of candidate compounds;

(ii) providing a micro fluidic system comprising at least two inlet channels that intersect to form a microfluidic channel, said microfluidic channel comprising three output channels, at least two of which, preferably the two outer output channels, are connected to a separate means for controlling and varying the flow, the central output channel containing the output stream of the channel, said central output channel being in fluid communication with the module for generating microdroplets;

(iii) flowing a first fluid in one inlet channel and an at least one second fluid containing a candidate compound in another inlet channel, the interface formed between the fluids in the microfluidic channel persisting for the length of the channel;

(iv) varying the relative flow rates into at least two output channels, preferably the outer output channels;

(v) combining the output stream of the central channel with one or several additional fluids, one additional fluid containing the target component;

(vi) generating microdroplets by combining the mix of the output stream of the central channel and said additional fluids with an oil phase, said microdroplets containing variable concentration of the candidate compound and the target component; and

(vii) repeating steps (iii) to (vi) for each candidate compound;

(viii) measuring the activity of each candidate compounds on the target component in each microdroplet; and

(viii) identifying candidate compounds which are active on the target component.

In another particular embodiment, the method comprises

(i) providing a library of candidate compounds;

(ii) providing a micro fluidic system comprising at least two inlet channels that intersect to form a microfluidic channel, said microfluidic channel comprising three output channels, at least two of which, preferably the two outer output channels, are connected to a separate means for controlling and varying the flow, the central output channel containing the output stream of the channel, said central output channel being in fluid communication with the module for generating microdroplets;

(iii) flowing a first fluid in one inlet channel and an at least one second fluid containing a candidate compound in another inlet channel, the interface formed between the fluids in the microfluidic channel persisting for the length of the channel;

(iv) varying the relative flow rates into at least two output channels, preferably the outer output channels;

(v) generating microdroplets by combining the output stream of the channel with an oil phase;

(vi) providing one or several additional set of microdroplets containing one or several additional fluids, one additional fluid containing the target component;

(vii) fusing microdroplets provided in step (vi) with microdroplets generated in step (v), fused microdroplets containing variable concentration of the candidate compound and the target component; and

(viii) repeating steps (iii) to (vii) for each candidate compound;

(ix) measuring the activity of each candidate compounds on the target componentin each microdroplet; and

(x) identifying candidate compounds which are active on the target component.

In another particular embodiment, the method comprises

(i) providing a library of candidate compounds;

(ii) providing a micro fluidic system comprising at least two inlet channels that intersect to form a microfluidic channel, said microfluidic channel comprising three output channels, at least two of which, preferably the two outer output channels, are connected to a separate means for controlling and varying the flow, the central output channel containing the output stream of the channel, said central output channel being in fluid communication with the module for generating microdroplets;

(iii) flowing a first fluid in one inlet channel and an at least one second fluid containing a candidate compound in another inlet channel, the interface formed between the fluids in the microfluidic channel persisting for the length of the channel;

(iv) varying the relative flow rates into at least two output channels, preferably the outer output channels;

(v) generating microdroplets by combining the output stream of the channel with an oil phase;

(vi) merging microdroplets generated in step (v) with stream(s) of one or several additional fluids, one additional fluid containing the target component, thereby obtaining microdroplets containing variable concentration of the candidate compound and the target component;

(vii) repeating steps (iii) to (vi) for each candidate compound;

(viii) measuring the activity of each candidate compounds on the target component in each microdroplet; and

(ix) identifying candidate compounds which are active on the target component.

All the embodiments of the method for generating variable concentration of a solute in microdroplets and of the method for determining a dose-response relationship in an at least two component system are also contemplated in this method.

In another aspect, the present invention provides a dilution micro fluidic system which can easily cover several orders of magnitude of dilution and allow the generation of high-resolution dose-response profiles.

The microfluidic system of the invention comprises a first module for generating variable concentrations of a solute in a solvent and a second module for generating droplets. The second module is connected downstream of the first module allowing to obtain droplets containing variable concentration of solute.

The micro fluidic system of the present invention may be or comprise silicon-based chips and may be fabricated using a variety of techniques, including, but not limited to, hot embossing, molding of elastomers, injection molding, LIGA, soft lithography, silicon fabrication and related thin film processing techniques. Suitable materials for fabricating a microfluidic device include, but are not limited to, cyclic olefin copolymer (COC), polycarbonate, poly(dimethylsiloxane) (PDMS), poly(methyl methacrylate) (PMMA), and glass. Preferably, microfluidic devices of the present invention are prepared by standard soft lithography techniques in PDMS and subsequent bonding to glass microscope slides. Due to the hydrophilic or hydrophobic nature of some materials, such as glass, which adsorbs some proteins and may inhibit certain biological processes, a passivating agent may be necessary. Suitable passivating agents are known in the art and include, but are not limited to silanes, fluorosilanes, parylene and n-dodecyl-β-D-maltoside (DDM).

In a first embodiment, the module for generating variable concentration of a solute in a solvent is a micro fluidic channel connected to means for introducing a pulse of solute to a stream of solvent flowing along said channel. In said microfluidic channel, the dispersion of the solute is dictated by the Taylor-Aris dispersion mechanism as described above.

The micro fluidic channel, or capillary, has an internal diameter of less than 1 mm. Preferably, the micro fluidic channel has an internal diameter ranging from 25 μm to 1 mm, more preferably from 50 μm to 500 μm, and even more preferably from 50 μm to 200 μm. In a particular embodiment, the microfluidic channel has an internal diameter ranging from 50 μm to 100 μm. In an embodiment, the microfluidic channel has a length ranging from 1 cm to 1 m, preferably from 25 cm to 75 cm. The internal diameter and the length of the microfluidic channel may be easily adjusted by the skilled person according to the targeted application. In particular, the skilled person may calculate the internal diameter and the length of the microfluidic channel based on the Taylor-Aris dispersion principle in order to obtain the desired profile of solute concentration at the end of said channel.

The pulse of solute may be introduced into the stream of solvent using a manual sample injector valve or an autosampler. In an embodiment, the pulse of solute is introduced into the stream of solvent using an autosampler, in particular an HPLC autosampler.

In a second embodiment, the module for generating variable concentrations of a solute in a solvent comprises at least two inlet channels that intersect to form a microfluidic channel, said microfluidic channel comprising three output channels, at least two of which are connected to separate means for controlling and varying the flow, and the central output channel being connected to the module for generating droplets.

Preferably, the two outer output channels are connected to separate means for controlling and varying the flow.

Typically, the microfluidic channel (also named scanning chamber) has a length ranging from 1 μm to 1 cm, preferably from 10 μm to 10 mm, more preferably from 10 μm to 1 mm, and a width ranging from 1 μm to 1 cm, preferably from 10 μm to 1 mm.

Suitable means for controlling and varying the flow of the output channels include, but are not limited to, valves, syringes or aspirating pumps. Suitable microfluidic valves include, for example, hydraulic, mechanic, pneumatic, magnetic, and electrostatic actuator flow controllers. Preferably, means for controlling and varying the flow of the output channels are aspirating pumps. The flow in each of the at least two output channel, preferably each outer output channel, can be controlled by a separate means. The output channels can also be connected to a single common outlet via a common flow control valve which regulates the relative flow rate in each of the at least two output channels. This allows to vary the flow rate in each output channel independently of the other.

At least one of the inlet channel may be in fluid communication with and downstream of a serial dilution microfluidic network comprising a plurality of channels having a plurality of intersections. Such a serial dilution microfluidic network has been described for example in the article of Jiang et al., 2003. This network creates various dilutions of a solute stream in a solvent stream by splitting, mixing, and joining the streams in a network of microfluidic channels. Typically, the module for generating variable concentrations of a solute in a solvent comprises at least two inlet channels that intersect to form a microfluidic channel, each of these inlet channels being connected to an outlet channel of a serial dilution micro fluidic network, wherein the serial dilution microfluidic network comprises several outlet channels, each of these channels containing a fluid with a different concentration of solute. Preferably, the module for generating variable concentrations of a solute in a solvent comprises at least four inlet channels, each of these channels being connected to an outlet channel of a serial dilution microfluidic network flowing a fluid with a different concentration of solute. One of these inlet channels may contain a fluid which does not contain the solute.

In the micro fluidic system of the invention, microdroplets are generated in a module for generating droplets which is in fluid communication and downstream of the output channel of the module for generating variable concentration of a solute in a solvent. The module for generating droplets may be easily designed by the skilled person based on any known techniques to produce droplets in a microfluidic device. These techniques include, but are not limited to, breakup in co-flowing streams, breakup in cross-flowing streams, for example at T-shaped junctions, breakup in elongational or stretching dominated flows, as for example in hydrodynamic flow-focussing (see Christopher and Anna, 2007). In a preferred embodiment, the module for generating droplets is a hydrodynamic flow-focussing module. This hydrodynamic flow-focussing module typically comprises (1) a nozzle and (2) two channels upstream of said nozzle, said channels intersecting the output channel of the module for generating solute variable concentration and being connected on each side of this output channel. An exemplary embodiment of this hydrodynamic flow-focussing module is illustrated in FIG. 10A, right drawing. The nozzle may have a width ranging from 1 μm to 500 μm and a height ranging from 1 μm to 500 μm, preferably a width ranging from 10 μm to 100 μm and a height ranging from 10 μm to 100 μm.

The micro fluidic system of the invention may also comprise at least one additional inlet channel downstream of the module for generating variable concentrations and connected to the output channel of said module, and upstream of the module for generating droplets. In an embodiment, the microfluidic system of the invention further comprises two additional inlet channel downstream of the module for generating variable concentrations and connected to each side of the output channel of said module, and upstream of the module for generating droplets.

The micro fluidic system of the invention may also comprise at least one additional inlet channel downstream of the module for generating droplets and connected to the output channel of said module.

The micro fluidic system of the invention may further comprise a second droplet generation module and/or an emulsion re-injection module connected to the output stream of the first module for generating droplets.

Droplets generated by the first droplet generation module and droplets generated by the second droplet generation module or injected by the emulsion re-injection module may be fused in a droplet fusion module. In an embodiment, this droplet fusion module is in fluid communication and downstream of the first module for generating droplets and downstream of the second module for generating droplets or of the emulsion re-injection module. An exemplary fusion module comprises a chamber and channel where the droplets coalesce either passively, or actively through, for example, introduction of hydrophilic patches on the chamber/channel walls or electrical fields (electrocoalescence).

The micro fluidic system of the invention may also comprise a delay line downstream of the module for generating droplets. The delay line allows incubation of reactions in droplets for a precise time periods. Such delay lines have been described for example in the international patent application WO 2010/042744.

The micro fluidic system of the invention may further comprise means for measuring optical signals, preferably for measuring fluorescence. Typically, these means are placed downstream of the module for generating droplets. If the microfluidic system comprises a delay line, these means may be placed upstream, downstream and/or within this delay line. In a preferred embodiment, these means for measuring optical signals are placed downstream of the delay line.

The system may further comprise data acquisition and control means to score and analyze optical signals emitted by droplets, in particular fluorescence signals.

In a particular embodiment, the micro fluidic system of the invention comprises
a module for generating variable concentrations of a solute in a solvent, as described above;
a module for generating droplets, as described above;
at least one additional inlet channel downstream of the module for generating variable concentrations and connected to the output channel of said module, and upstream of the module for generating droplets, as described above;
a delay line downstream of the module for generating droplets, as described above; and
means for measuring optical signals and placed upstream, downstream and/or within the delay line, preferably downstream, as described above.

Preferably, the micro fluidic system comprises two additional inlet channels downstream of the module for generating variable concentrations and connected to the output channel of said module, and upstream of the module for generating droplets.

The following examples are given for purposes of illustration and not by way of limitation.

### EXAMPLES

### Example 1

A useful implementation of droplet micro fluidics would be to study the properties or effects of a chemical or biochemical species as a function of concentration. Example applications for variable concentration microdroplets are the investigation of concentration-response relationships and the determination of biological constants such as K_{M} (the Michaelis constant). Variable concentration microdroplets could also be used to construct phase diagrams for physical and chemical phenomena such as chemical solubility, crystallization, and polymerization. The measurement of K_{M} is an important step in the characterization of an enzyme/substrate system. Performing a series of reactions at different substrate concentrations and then plotting the reaction velocity against substrate concentration typically determine this constant. Similarly, modulating the concentration of inhibitor and measuring reaction velocity can determine the dose-response relationship for an enzyme/substrate/inhibitor system. A sigmoidal curve is fit to this data and the IC₅₀ and IC₉₀ values for the system can be read off: these values correspond to the concentrations of inhibitor that cause a 50% or 90% decrease in enzymatic activity, respectively.

Experimental Materials and Methods

Materials

In the examples, the model systems comprised an enzyme, a substrate, and an inhibitor for IC₅₀ measurements and an enzyme and substrate alone for K_{M} measurements. In all cases the enzyme was β-galactosidase (Sigma-Aldrich Co.), the substrate was resorufin β-D-galactopyranoside (RBG; Invitrogen Corporation), and the inhibitor was phenylethyl β-D-thiogalactopyranoside (PETG; Invitrogen Corporation).

Other components in the model systems were bovine serum albumin (BSA; Sigma-Aldrich Co.) and dimethyl sulfoxide (DMSO; Sigma-Aldrich Co.). The buffer was always 1× phosphate-buffered saline (PBS; Sigma-Aldrich Co.).

The surfactant for all emulsions was EA (RainDance Technologies, Inc.), a PEGPFPE amphiphilic block copolymer surfactant (Holtze et al., 2008), and the oil phase was HFE-7500 fluorinated oil (3M).

Analytical Workstation 1

The first analytical workstation consisted of standard free-space optics mounted on a vibration-dampening platform (Thorlabs GmbH). A 20 mW, 488 nm solid-state laser and a 20 mW, 561 nm solid-state laser (Coherent, Inc.) were combined and focused to a 20 μm-wide spot with a 20×/0.45 microscope objective (Nikon Instruments, Inc.). Fluorescent emissions passed back through the objective and were separated from the laser beams. Two H9656-20 photomultiplier tubes (PMTs; Hamamatsu Photonics KK) measured the intensities of two bands of wavelengths in the fluorescent emissions: 500-520 and 590-625 nm. Data acquisition was performed by a PCI-7831R Multifunction Intelligent DAQ card (National Instruments Corporation) executing a program written in LabView 8.6 (National Instruments Corporation).

A continuous stream of buffer was pumped from a Unimate 3000 high-performance liquid chromatography (HPLC) autosampler (Dionex Corporation) to the microfluidic device installed in the workstation via a 50 cm length of PEEKSil capillary tubing (0.1 mm internal diameter and 0.8 mm external diameter; IDEX Corporation). The internal surface of the capillary was rendered hydrophobic by performing the following steps: (i) the capillary was filled with a 1% (v/v) solution of 1H,1H,2H,2Hperfluorodecyltrichloro-silane in HFE-7500; (ii) the fluorinated solution was purged from the capillary using a source of compressed nitrogen gas; and (iii) the capillary was heated to 50° C. for 10 minutes.

Liquids were pumped by controlled delivery modules (IDEX Corporation) and liquidexchange reservoirs (RainDance Technologies, Inc.). The pumps and liquid-exchange reservoirs were connected to the microfluidic device by polyaryletheretherketone (PEEK) tubing (0.254 mm internal diameter and 0.8 mm external diameter; IDEX Corporation).

Analytical Workstation 2

The second analytical workstation consisted of an Axiovert 200 inverted microscope (Carl Zeiss SAS) mounted on a vibration-dampening platform (Thorlabs GmbH). A 20 mW, 488 nm solid-state laser and a 20 mW, 532 nm solid-state laser (both Newport Corporation) were combined and focused to a 20 μm-wide spot with a 40×/0.6 microscope objective (Carl Zeiss SAS). Fluorescent emissions passed back through the objective and were separated from the laser beams. Two H5784-20 PMTs (Hamamatsu Photonics KK) measured the intensities of two bands of wavelengths in the fluorescent emissions: 500-520 and 590-625 nm. Data acquisition was performed by a PCI-7831R Multifunction Intelligent DAQ card (National Instruments Corporation) executing a program written in LabView 8.2 (National Instruments Corporation).

Liquids were pumped by neMESYS syringe pumps (Cetoni GmbH). Syringes were connected to the microfluidic device using 0.6×24 mm Neolus needles (Terumo Corporation) and polytetrafluoroethylene (PTFE) tubing (0.56 mm internal diameter and 1.07 mm external diameter; Fisher Bioblock Scientific).

Manufacturing Microfluidic Devices

Each microfluidic device was fabricated using soft lithography (Duffy et al., 1998) by pouring poly(dimethylsiloxane) (PDMS; Sylgard 184; Dow Corning Corporation) onto a positive-relief silicon wafer (Siltronix SAS) patterned with SU-8 photoresist (Microchem Corporation). Curing agent was added to PDMS base to a final concentration of 10% (w/w), degassed and poured over the mould for crosslinking at 65° C. for 16 hours. The structured PDMS layer was peeled off the mould and the inlet and outlet holes were punched with a 0.5 mm-diameter Harris Uni-Core biopsy punch (Electron Microscopy Sciences). The microfluidic channels were sealed by bonding the PDMS slab to a glass microscopy slide using an oxygen plasma (PlasmaPrep 2 plasma oven; GaLa Instrumente GmbH). Finally, the channels were treated with 1H,1H,2H,2H-perfluorodecyltrichlorosilane to render them hydrophobic (see above section Analytical workstation 1).

### Example 1a

This example demonstrates how the concentration of a solute (sodium fluorescein) can be varied using the dilution system of the invention illustrated in FIG. 1A.

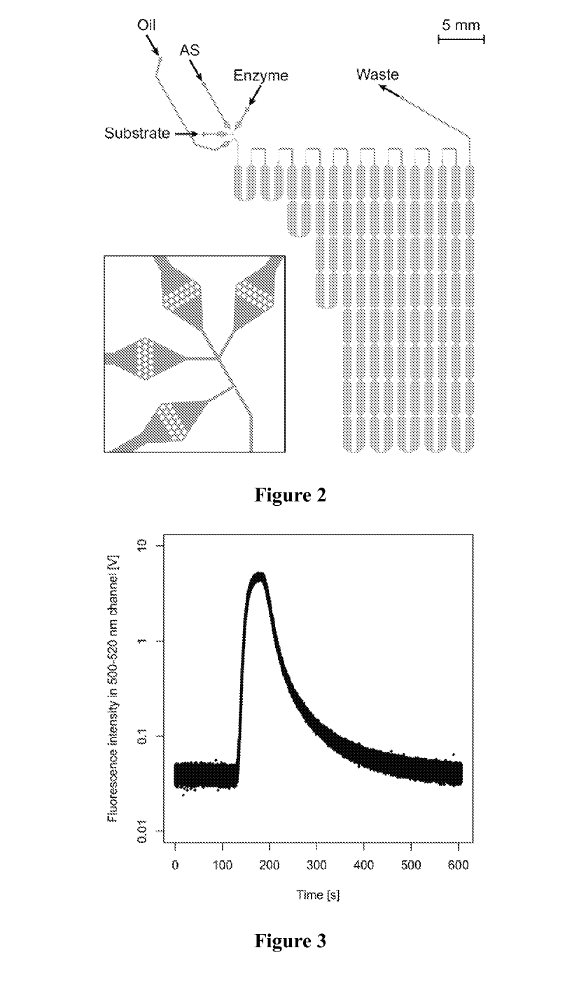

A micro fluidic emulsion of 90 pl aqueous microdroplets was generated by injecting the microfluidic device (FIG. 2) with an oil phase and an aqueous phase. The oil phase consisted of 1% (w/w) EA surfactant dissolved in HFE-7500 flowing at 680 μl/hr. The aqueous phase was the mobile phase from the HPLC autosampler flowing at 1,000 μl/hr: PBS. On-chip, the aqueous phase was segmented into microdroplets by the oil phase.

The autosampler was used to introduce a single 1 μl pulse of 100 μM sodium fluorescein (a fluorophore) to the PBS flowing to the device through the silane-treated capillary.

As the pulse travelled along the capillary, the ends of the pulse diffused into the surrounding PBS by Taylor dispersion, creating concentration gradients of sodium fluorescein. When the pulse reached the point of droplet formation inside the microfluidic device, a series of microdroplets were created containing sodium fluorescein at different concentrations: from zero to 100 μM and then from 100 μM to zero. The microdroplets passed one at a time through the 488 nm laser spot positioned just after the point of droplet creation (see above, section Analytical workstation 1). The fluorescence intensity of each droplet was measured in the 500-520 nm channel.

Droplet fluorescence intensity was plotted against time (FIG. 3), revealing that the measured fluorescence intensity covered a 2 log step range. Assuming a linear relationship between sodium fluorescein concentration and fluorescence intensity, the actual concentration of sodium fluorescein in the droplets varied by at least 2 log steps.

### Example 1b

This example demonstrates how the concentration of a solute (sodium fluorescein) can be varied using the dilution system of the invention illustrated in FIG. 1C.

An aqueous phase of 100 μM sodium fluorescein (a fluorophore) in PBS was injected into the ‘compound’ input of the micro fluidic device (FIG. 4) at a flow rate of 111 μl/hr. A second aqueous phase, PBS, was injected into the ‘diluent’ input at a flow rate of 389 μl/hr. The dilution network in the device split and mixed these flows to generate a laminar flow into the scanning chamber with four discrete concentrations of the inhibitor side-by-side: 100 μM, 10 μM, 1 μM, and 0 μM. The flow rate of each aspirating pump connected to the scanning chamber was ramped up and down between 20 and 320 μl/hr as a triangle wave with a 75 second period. The two waves were 180° out of phase so that the total aspirating flow rate was always 340 μl/hr, leaving an output stream of 160 μl/hr. 1% (w/w) EA surfactant dissolved in HFE-7500 flowing at 400 μl/hr was used to flow-focus the combined aqueous streams and generate 90 pl aqueous microdroplets.

A series of microdroplets were created containing sodium fluorescein at different concentrations: from zero to 100 μM and then from 100 μM to zero. The microdroplets passed one at a time through the 488 nm laser spot positioned just after the point of droplet creation (see above section Analytical workstation 2). The fluorescence intensity of each droplet was measured in the 500-520 nm channel.

Droplet fluorescence intensity was plotted against time (FIG. 5), revealing that the measured fluorescence intensity covered a 3 log step range. Assuming a linear relationship between sodium fluorescein concentration and fluorescence intensity, the actual concentration of sodium fluorescein in the droplets varied by at least 3 log steps.

### Example 1c

This example employs the dilution system of the invention illustrated in FIG. 1A to determine the IC₅₀ of the inhibitor in the model enzyme/substrate/inhibitor system (see above section Materials).

A microfluidic emulsion of 90 pl aqueous microdroplets was generated by injecting the microfluidic device (FIG. 2) with an oil phase and three aqueous phases. The oil phase consisted of 1% (w/w) EA surfactant dissolved in HFE-7500 flowing at 680 μl/hr. The aqueous phases were: (i) the enzyme solution flowing at 30 μl/hr: 2.67 U/ml β-galactosidase and 3.3 g/l BSA in PBS; (ii) the substrate solution flowing at 80 μl/hr: 520 μM RBG and 5% (v/v) DMSO in PBS; and (iii) the mobile phase from the HPLC autosampler flowing at 50 μl/hr: PBS. The three aqueous phases were combined at a single point on-chip before being segmented into microdroplets by the oil phase.

The autosampler was used to introduce a single 1 μl pulse of 120 μM PETG (the inhibitor) to the PBS flowing to the device through the silane-treated capillary. The inclusion of 40 μM of the fluorophore sodium fluorescein with the inhibitor allowed the concentration of PETG to be inferred downstream from the degree of fluorescence observed in the 500-520 nm channel.

As the pulse travelled along the capillary, the ends of the pulse diffused into the surrounding PBS by Taylor dispersion, creating concentration gradients of PETG and sodium fluorescein. When the pulse reached the point of droplet formation inside the microfluidic device, a series of microdroplets were created containing PETG (and sodium fluorescein) at different concentrations: from zero to 30 μM (10 μM sodium fluorescein) and then from 30 μM to zero. The microdroplets flowed through a 30 second delay line (Frenz et al., 2009) in the microfluidic device and then passed one at a time through the 488 and 561 nm laser spot (see above section Analytical workstation 1). The amounts of fluorescent resorufin (liberated by β-galactosidase activity) and sodium fluorescein were measured for each droplet by monitoring fluorescence intensity in the 590-625 and 500-520 nm channels, respectively.

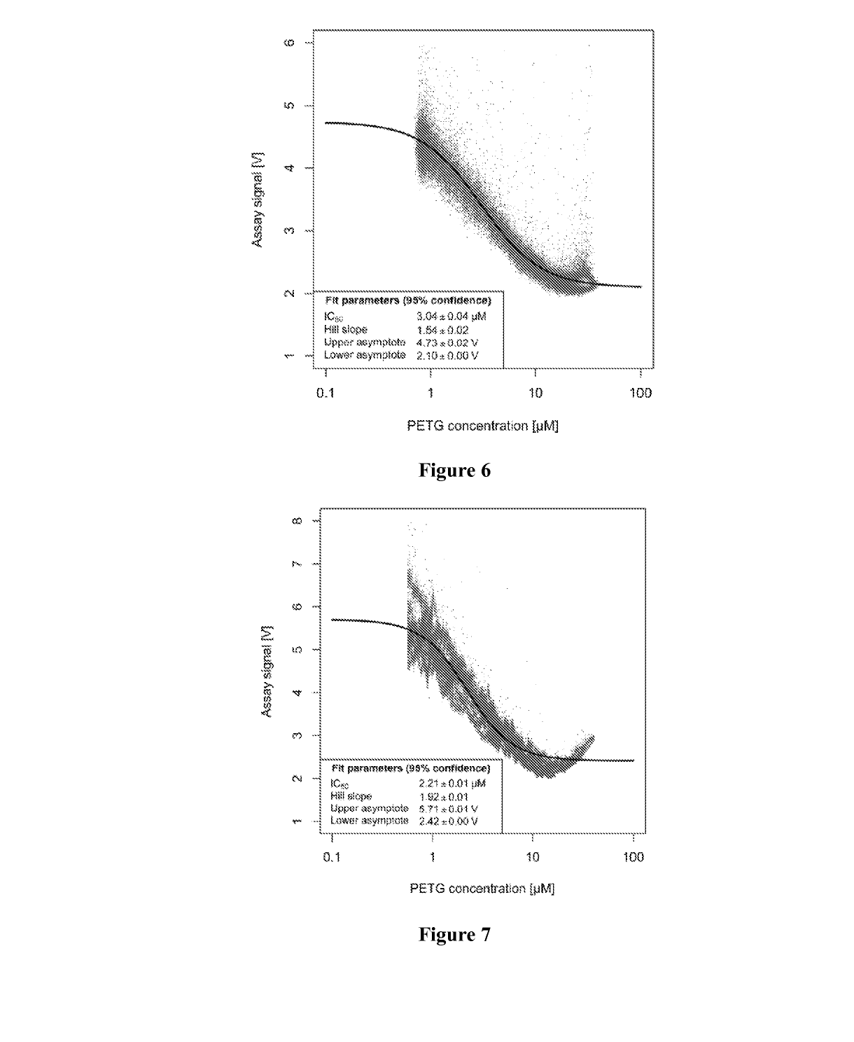

The microdroplets in the initial climb in inhibitor concentration (the leading front of the inhibitor pulse) were plotted in an XY graph with initial reaction rate (inferred from resorufin fluorescence after 30 seconds of droplet incubation) against inhibitor concentration (assumed to be proportional to sodium fluorescein fluorescence). A 4-parameter log-logistic curve was fitted to the points using the DRC package (Ritz et al., 2005) in R(R Development Core Team 2009) (FIG. 6). The IC₅₀ of PETG in the described enzyme/substrate/inhibitor system was found to be 3.04 μM (95% confidence intervals: 3.00-3.08 μM). This value compares favorably to the value measured in a standard microplate assay: 1.43 μM (95% confidence intervals: 1.37-1.49 μM).

### Example 1d

This example employs the dilution system of the invention illustrated in FIG. 1C to determine the IC₅₀ of the inhibitor in the model enzyme/substrate/inhibitor system (see above section Materials).

An aqueous phase of 120 μM PETG (the inhibitor) and 100 μM sodium fluorescein in PBS were injected into the ‘compound’ input of the micro fluidic device (FIG. 4) at a flow rate of 111 μl/hr. A second aqueous phase, PBS, was injected into the ‘diluent’ input at a flow rate of 389 μl/hr. The dilution network in the device split and mixed these flows to generate a laminar flow into the scanning chamber with four discrete concentrations of the inhibitor side-by-side: 120 μM, 12 μM, 1.2 μM, and 0 μM. The flow rate of each aspirating pump connected to the scanning chamber was ramped up and down between 20 and 430 μl/hr as a triangle wave with a 60 second period. The two waves were 180° out of phase so that the total aspirating flow rate was always 450 μl/hr, leaving an output stream of 50 μl/hr. The output stream was combined with two further aqueous streams on-chip: (i) the enzyme solution flowing at 30 μl/hr: 2.67 U/ml β-galactosidase and 5.3 g/l BSA in PBS; and (ii) the substrate solution flowing at 80 μl/hr: 520 μM RBG and 5% (v/v) DMSO in PBS. 1% (w/w) EA surfactant dissolved in HFE-7500 flowing at 400 μl/hr was used to flow-focus the combined aqueous streams and generate 90 μl aqueous microdroplets.

A series of microdroplets were created containing PETG (and sodium fluorescein) at different concentrations: from zero to 30 μM (25 μM sodium fluorescein) and then from 30 μM to zero. The microdroplets flowed through a 75 second delay line in the microfluidic device and then passed one at a time through the 488 and 532 nm laser spot (see above section Analytical workstation 2). The amounts of fluorescent resorufin (liberated by β-galactosidase activity) and sodium fluorescein were measured for each droplet by monitoring fluorescence intensity in the 590-625 and 500-520 nm channels, respectively.

About 10⁵ microdroplets were plotted in an XY graph with initial reaction rate (inferred from resorufin fluorescence after 75 seconds of droplet incubation) against inhibitor concentration (assumed to be proportional to sodium fluorescein fluorescence). A 4-parameter log-logistic curve was fitted to the points using the DRC package in R (FIG. 7). The IC₅₀ of PETG in the described enzyme/substrate/inhibitor system was found to be 2.21 μM (95% confidence intervals: 2.20-2.22 μM). This value compares favorably to the value measured in a standard microplate assay: 1.43 μM (95% confidence intervals: 1.37-1.49 μM).

### Example 1e

This example employs the dilution system of the invention, illustrated in FIG. 1C, to determine the K_{M} of the substrate in the model enzyme/substrate system (see above section Materials).

An aqueous phase of 520 μM RBG (the substrate), 100 μM sodium fluorescein, and 5% (v/v) DMSO in PBS were injected into the ‘compound’ input of the microfluidic device (FIG. 4) at a flow rate of 111 μl/hr. A second aqueous phase, 5% (v/v) DMSO in PBS, was injected into the ‘diluent’ input at a flow rate of 389 μl/hr. The dilution network in the device split and mixed these flows to generate a laminar flow into the scanning chamber with four discrete concentrations of the inhibitor side-by-side: 520 μM, 52 μM, 5.2 μM, and 0 μM. The flow rate of each aspirating pump connected to the scanning chamber was ramped up and down between 20 and 400 μl/hr as a triangle wave with a 75 second period. The two waves were 180° out of phase so that the total aspirating flow rate was always 420 μl/hr, leaving an output stream of 80 μl/hr. The output stream was combined on-chip with the enzyme solution flowing at 80 μl/hr: 1 U/ml β-galactosidase and 2 g/l BSA in PBS. 1% (w/w) EA surfactant dissolved in HFE-7500 flowing at 400 μl/hr was used to flow-focus the combined aqueous streams and generate 90 pl aqueous microdroplets.

A series of microdroplets were created containing RBG (and sodium fluorescein) at different concentrations: from zero to 260 μM (50 μM sodium fluorescein) and then from 260 μM to zero. The microdroplets flowed through a 75 second delay line in the microfluidic device and then passed one at a time through the 488 and 532 nm laser spot (see above section Analytical workstation 2). The amounts of fluorescent resorufin (liberated by β-galactosidase activity) and sodium fluorescein were measured for each droplet by monitoring fluorescence intensity in the 590-625 and 500-520 nm channels, respectively.

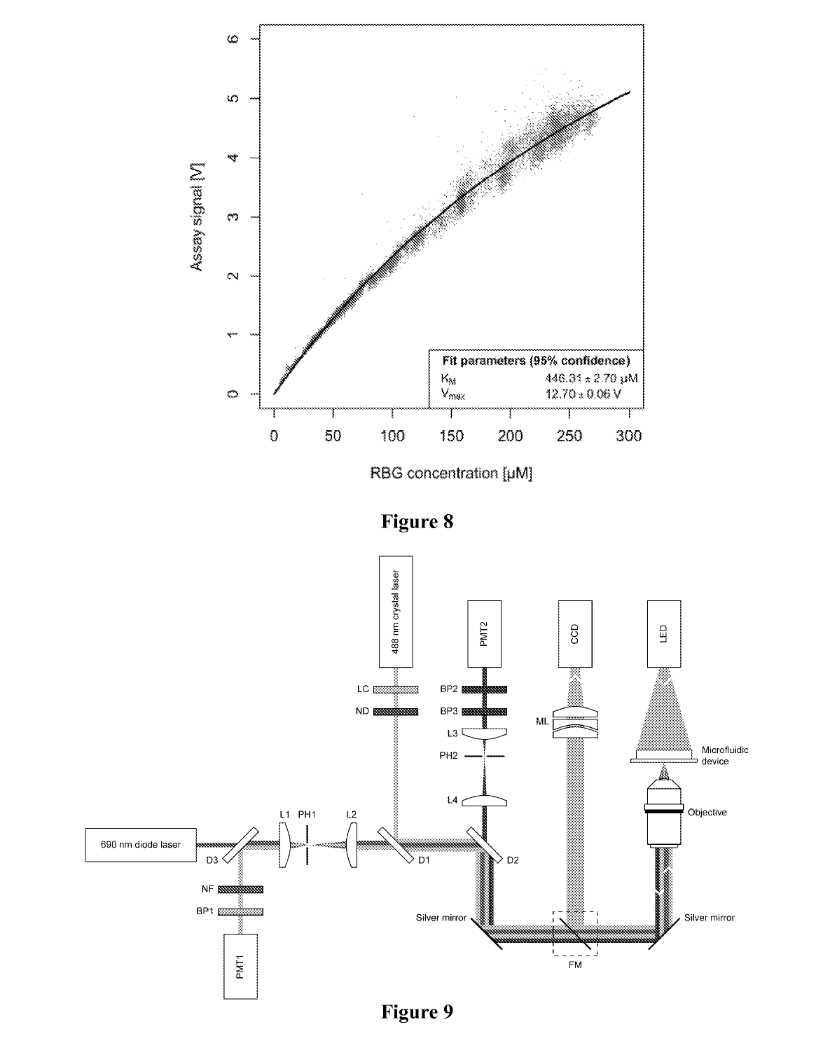

A Michaelis-Menten curve was fitted to the points using the DRC package in R (FIG. 8). The K_{M} of RBG in the described enzyme/substrate system was found to be 446.31 μM (95% confidence intervals: 432.68-437.05 μM). This value compares favorably to the value measured in a standard microplate assay: 115.6 μM (95% confidence intervals: 102.7-128.6 μM).

### Example 2

### Materials and Methods

Materials

All materials were obtained from Sigma-Aldrich Co. (Missouri, USA), unless otherwise stated.

Analytical Workstation

The analytical workstation consisted of standard free-space optics mounted on a vibration-dampening platform. FIG. 9 shows the complete optical setup used for measuring the fluorescence of microfluidic droplets in two color channels: green and near infrared (NIR). This setup was based around a 20× Plan Fluor microscope objective lens with a numerical aperture of 0.45 (Nikon Corp., Tokyo, Japan). In addition to focusing laser light and collecting emitted light, this lens also provided a means of imaging the microfluidic device. Transmission imaging was achieved using a 780 nm light-emitting diode (“LED”; Epoxy-Encased LED780E; Thorlabs, Inc., New Jersey, USA) as the light source and a Guppy charge-coupled device camera (“CCD”; Allied Vision Technologies GmbH, Stadtroda, Germany) fitted with a 50 mm macro lens (Stemmer Imaging GmbH, Puchheim, Germany). After alignment, a flip-mounted mirror (“FM”; Thorlabs, Inc., New Jersey, USA) was moved out of the light path, switching the system from imaging mode to fluorescence-measurement mode.

Excitation of green fluorescent dyes was achieved with a 30 mW, 488 nm Sapphire solid-state laser (“488 nm crystal laser”; Coherent, Inc., California, USA). A 488 nm laser-cleanup filter (“LC”; Semrock, Inc., New York, USA) and an ND2 neutral-density filter (“ND”) were placed in front of the laser to, respectively, eliminate an emission at 1,000 nm and to reduce the power of the laser. Excitation of NIR-fluorescing dyes was achieved with a 30 mW, 690 nm diode laser (“690 nm diode laser”; Newport Corp., California, USA). The two lasers were combined with a FF498/581 dichroic mirror (“D1”; Semrock, Inc., New York, USA). Two plano-convex lenses, “L1” (12 mm diameter, 30 mm focal length) and “L2” (25 mm diameter, 150 mm focal length) (both from Edmund Optics, Inc., New Jersey, USA), formed a 5× Galilean beam expander, increasing the 1/e2 width of the two beams to 9 mm. A 800 μm-diameter pinhole (“PH1”; Thorlabs, Inc., New Jersey, USA) was placed in the focal plane between L1 and L2 to act as a spatial filter and reduce laser speckle.

Light emitted by fluorescing droplets passed back along the same optical path as the lasers and was separated into visible light and NIR light by a FF750 dichroic (“D2”; Semrock, Inc., New York). Visible light passed through the L1/L2 lens assembly where the pinhole reduced the sectioning power at the focal plan, much like a confocal optical system. This had the benefit of reducing the backscatter from the lasers and the fluorescence emission from the silicone polymer of the microfluidic device. An FF677 dichroic (“D3”; Semrock, Inc., New York, USA), directed the emitted visible light to the green light detector, an H9656 photomultiplier (“PMT1”; Hamamatsu Photonics KK, Shizuoka, Japan), via a 690 nm notch filter (“NF”; Supplier) and a green FF01-529/28 band-pass filter (“BP1”; Semrock, Inc., New York). A second spatial filter, consisting of two plano-convex lenses (L3 and L4) and a pinhole (PH2) (identical to the L1/L2/PH1 assembly), was used to spatially-filter the emitted NIR light. This light was then detected by “PMT2”, a second H9656-20 PMT for NIR emissions, via two stacked NIR FF01-794/160-25 filters (“BP2” and “BP3”; Semrock, Inc., New York, USA).

Data acquisition was performed by a PCI-7831R Multifunction Intelligent DAQ card (National Instruments Corporation) executing a program written in LabView 8.6 (National Instruments Corporation).

A continuous stream of buffer was pumped from a Unimate 3000 high-performance liquid chromatography (HPLC) autosampler (Dionex Corporation) to the microfluidic device installed in the workstation via a 50 cm length of PEEKSil capillary tubing (75 μm internal diameter and 0.8 mm external diameter; IDEX Corporation). The internal surface of the capillary was passivated with 1H,1H,2H,2H-perfluorodecyltrichlorosilane before use (see above section Analytical workstation 1 in Example 1).

Liquids were pumped by controlled delivery modules (IDEX Corporation) and liquid-exchange reservoirs (RainDance Technologies, Inc.). The pumps and liquid-exchange reservoirs were connected to the microfluidic device by polyaryletheretherketone (PEEK) tubing (0.254 mm internal diameter and 0.8 mm external diameter; IDEX Corporation).

Autosampler Setup

A WPS-3000 HPLC autosampler (Dionex Corp., California, USA), fitted with a 10 μl PTFE injection loop, was programmed with a customized injection program to load 1 μl samples from 96- or 384-well plates into a continuous stream of buffer: (i) the injection valve was switched to the “Load” position; (ii) 8 μl of the sample was slowly aspirated into the injection loop (140 nl/s); (iii) the injection valve was switched to the “Inject” position for 18 seconds (with a buffer flow rate of 200 μl/hour, this corresponded to an injection volume of 1 μl); (iv) the injection valve was returned to the “Load” position and the sample needle was washed with 500 μl of 10% (v/v) DMSO.

Microfluidic Devices

Each microfluidic device was prepared from poly(dimethylsiloxane) (PDMS) by standard soft-lithography techniques. Following the manufacturer's instructions, SU-8 2025 photoresist (MicroChem Corp., Massachusetts, USA) was spin-coated on a silicon wafer (Siltronix, Archamps, France) to a depth of 25 μm using a WS-400B-6NPP-Lite spin coater (Laurell Technologies Corp., Pennsylvania, USA). An MJB3 contact mask aligner (SUSS MicroTec Lithography GmbH, Garching, Germany) was used to expose the coated wafer to UV light through a photolithography mask (FIG. 10; printed by Selba SA, Versoix, Switzerland). Non-crosslinked photoresist was removed using SU-8 developer (MicroChem Corp., Massachusetts, USA), leaving patterned microchannels of crosslinked SU-8 on the surface of the silicon wafer. A second set of channels, 75 μm deep, was added to the silicon wafer using the same procedure, but using SU-8 2075 photoresist (MicroChem Corp., Massachusetts, USA) in place of the SU-8 2025.

Curing agent was added to PDMS base (Sylgard 184 silicone elastomer kit; Dow

Corning Corp., Michigan, USA) to a final concentration of 10% (w/w), mixed and poured over the patterned silicon wafer to a depth of 5 mm. The mixed PDMS was degassed under vacuum for several minutes and then allowed to crosslink at 65° C. for several hours. After hardening, the PDMS was peeled off the mould and the input and output ports were punched with a 0.5 mm-diameter Harris Uni-Core biopsy punch. Particles of PDMS were cleared from the ports using pressurized nitrogen gas. The structured side of the PDMS slab was bonded to a 76×26×1 mm glass microscope slide (Paul Marienfeld GmbH & Co. KG, Lauda-Königshofen, Germany) by exposing both parts to an oxygen plasma (PlasmaPrep 2 plasma oven; GaLa Instrumente GmbH, Bad Schwalbach, Germany) and pressing them together. Finally, an additional hydrophobic surface coating was applied to the microfluidic channel walls by injecting the completed device with 1% (v/v) 1H,1H,2H,2H-perfluorodecyltrichlorosilane in HFE-7500 and heating it to 70° C. for 2 hours. Excess fluorosilane was rinsed from the device using pure HFE-7500.

The device (FIG. 10) was designed with three aqueous inlets, one for connection to the autosampler via the capillary for injection of the compounds, and the other two for injection of the enzyme solution and the substrate solution. The aqueous flows were combined on-chip and passed through a nozzle with a height of 25 μm and a width of 25 μm. HFE-7500 containing 0.5% (w/w) EA surfactant (RainDance Technologies, Inc., Massachusetts, USA), a biocompatible PEG-PFPE amphiphilic block copolymer, flowing from each side of the nozzle segmented the aqueous stream into droplets. The droplets were produced at a rate of ˜800 per second, indicating that they had a volume of ˜140 pl each. After production, the droplets flowed into a deep (75 μm), wide (1.2 mm) delay line where their mean velocity decreased dramatically from 22.2 to 0.247 cm/s. The delay line contained 50 μm-wide constrictions every 3.39 mm to enable re-shuffling of the droplets. Additionally, at several points along the delay line the serpentine deep channels passed into shallower (25 μm), narrower (40 μm) regions where the droplets could be analyzed by the optical setup. Passive droplet-respacing features were integrated just before these analysis points to improve the discrimination of single droplets. These features consisted of a channel that jumped in width from 50 to 200 μm, where the droplets tended to follow a central trajectory and the oil passed along the sides. As the channel constricted to 40 μm before the analysis point, the oil moved between the droplets, forcing them apart. The delay line allowed incubation times of 3.75 to 210 seconds at the flow rates used.

Theoretical Framework for Taylor-Aris Dispersion

In a series of three papers published in 1953 and 1954, Sir Geoffrey Taylor solved the problem addressed earlier by Albert Griffiths (Griffiths, 1910) of how a soluble compound is carried in a flow and its concentration in the stream at a given position and time as a function of its initial distribution. Taylor solved the problem in the case of laminar flow (Taylor, 1953) and showed that the concentration profile is controlled by the interplay of flow velocity and solute diffusion. From this he derived a method to measure the diffusion coefficient of a compound from its distribution in the flow (Taylor, 1954). Two years later, this series of papers was complemented by a paper by Rutherford Aris (Aris, 1956), which provided a generalization of Taylor's description. Below, the framework of so-called Taylor-Aris dispersion is described.

The problem studied by Taylor deals with the distribution of a solute initially concentrated at one position in a tube of constant diameter 2R and advected by a flow at a flow rate Q. The flow profile in the laminar regime with a no-slip boundary condition on the wall of the tube is a Poiseuille flow. The velocity u(r) is a parabolic function of the sole radial position with a maximum uₘ in the center of the tube: u(r)=uₘ(1−(r/R)²), where uₘ=2Q/πR². The velocity of the flow in the center of the tube is twice the average velocity across the tube U=Q/πR². If the solute is localized at a well-defined z position in the tube at an initial time, the solute in the middle of the tube will move faster than the solute on the edge. In the absence of diffusion, this would stretch the distribution of the solute along z. In the absence of flow, but taking diffusion into account (D being the diffusion coefficient of the solute), an initially heterogeneous distribution of solute in a liquid will tend to diffuse over the whole tube volume to homogenize the concentration at equilibrium. Formally, the concentration c of solute is a function of r, z and t. Taylor considered the averaged concentration C of solute in a slice z and showed that when the time-scale τ_{D} of diffusion over a distance R (τ_{D}˜R²/D) is shorter than the time to move a volume of fluid over a distance of one radius (the advection time-scale τ_{A}˜R/U), i.e. when UR/D>>1, then C follows a diffusion-like equation in the frame of reference of the center of mass of the solute z′=z−Ut:

∂ₜc=D_{eff}∂_{z′}_{²}C (4)

with D_{eff}=R²U²/48D, the effective diffusion coefficient. It should be noted that the effective diffusion coefficient is inversely proportional to the diffusion coefficient, which is counterintuitive: molecular diffusion decreases the effect of flow dispersion. In Taylor dispersion, convection and diffusion interplay: diffusion redistributes the solute in the radial direction while convection promotes the dispersion along the tube axis (FIG. 16). In his second paper on the subject (Taylor, 1954), Taylor described his argument in a more detailed way and showed that such a diffusion equation was valid, provided that a second condition was fulfilled: L/U>>R²U/D where L is the length of tube in which significant changes in concentration occur (here, the tube length at which the concentration is measured). Finally, Aris (Aris, 1956) showed that Eq. 4 could be generalized: the constraint on the value of UR/D is released when using an effective dispersion coefficient D_{eff}=D+R²U²/48D. Using this expression for D_{eff}, Eq. 5 is then the equation describing so-called Taylor-Aris dispersion in the frame of reference of the tube.

∂ₜC+U∂_{z}C=D_{eff}∂_{z}_{²}C (5)

Solutions for the diffusion equation are known. In order to solve Eq. 5 for all z and t values for any initial condition, the Green function of the system was used, which is the response to a Dirac initial condition C(z,0)=δ(Z):

$$G ( z , t ) = \frac{1}{\sqrt{4 π {D}_{eff} t}} exp ( \frac{- {( z - Ut )}^{2}}{4 {D}_{eff} t} ) \qquad ( 6 )$$

The profile C(z,t) generated from an initial distribution of concentration of dye in the tubing C(z,0) is then the product of the convolution C(z,t)=C(z,0)×G(z,t). When a plug of dye of volume V is injected in the capillary, the initial condition C(z,0) corresponds to a square function of length Lₚ=V/πR² and amplitude C₀. In this case, C(z,t) is analytically expressed as:

$$C ( z , t ) = \frac{{C}_{0}}{2} ( erf \frac{{L}_{p} + z - Ut}{\sqrt{4 {D}_{eff} t}} - erf \frac{z - Ut}{\sqrt{4 {D}_{eff} t}} ) \qquad ( 7 )$$

where erf is the so-called error function. When the concentration is measured at a fixed point z=Lₘ as a function of time, the fluorescence signal is then simply proportional to the value at the measurement point C(Lₘ,t):

$$C ( {L}_{m} , t ) = \frac{{C}_{0}}{2} ( erf \frac{{L}_{m} + {L}_{p} - Ut}{\sqrt{4 {D}_{eff} t}} - erf \frac{{L}_{m} - Ut}{\sqrt{4 {D}_{eff} t}} ) \qquad ( 8 )$$

Characterization of Taylor-Aris Dispersion

Injections of 50 μM fluorescent dye were added to a 200 μl/hour flow of phosphate-buffered saline (PBS) through the autosampler. On-chip, the flow was segmented into droplets by the oil/surfactant solution flowing at 300 μl/hour. The optical setup was positioned just before the delay line and individual droplets were discriminated by the rise and fall in green fluorescence as they passed through the laser spot. A small concentration of fluorescein, 50 nM, was present in the PBS to allow the discrimination of all droplets, including those that were “outside” the injections.

The dispersion profiles of the following fluorescent dyes were measured: the green fluorescent dyes ATTO 488, BODIPY FL (Invitrogen Corp., California, USA), DyLight 488 (Pierce Biotechnology, Inc., Illinois, USA), and sodium fluorescein; and the NIR fluorescent dye DY-682 (Dyomics GmbH, Jena, Germany). These profiles were then fitted with equation 8 (Eq. 8 above). In addition, the peak fluorescence values for the injections of DY-682 were compared with a 100 μM calibration standard of DY-682 in order to determine the mean peak concentration of DY-682 in each injection.

Determining the Kinetic Profile of Enzymatic Activity on-Chip

To determine the correct incubation time for measuring β-galactosidase activity under initial rate conditions on-chip, a solution of E. coli Grade VIII β-galactosidase was diluted to 20 U/ml in PBS containing 4 g/l bovine serum albumin (BSA) and injected at a rate of 100 μl/hour into one of the aqueous ports of the microfluidic device. The second aqueous input was PBS flowing at a rate of 200 μl/hour. The final aqueous input was the substrate solution containing the fluorogenic β-galactosidase substrate fuorescein di-β-D-galactopyranoside (FDG; Invitrogen Corp., California, USA) at 240 μM concentration, 4-fold greater than its K_{M}. The substrate solution also contained 200 nM sodium fluorescein to allow detection of the droplets before incubation. The combined aqueous flow was segmented into droplets by the oil/surfactant solution flowing at a rate of 400 μl/hour. Approximately 24,000 droplets were analyzed by the optical setup at each measurement point of the delay line. The mean green fluorescence at each point was then plotted against incubation time to build a kinetic profile for β-galactosidase activity on-chip and determine the initial linear region.

The kinetic profile for protein tyrosine phosphatase 1B (PTP1B) activity was constructed in a similar manner, but with the following changes: 50 mM HEPES pH 7.2 was used in place of PBS; the enzyme solution was 20 mg/l PTP1B (EMD Biosciences, Inc., California, USA) in 50 mM HEPES pH 7.2 containing 4 mM dithiothreitol (DTT), 4 mM ethylenediaminetetraacetic acid (EDTA), and 4 g/l BSA; and the substrate solution was 68 μM fluorescein diphosphate (FDP) in 50 mM HEPES pH 7.2.

High-Resolution Dose-Response Screening of β-Galactosidase Inhibition

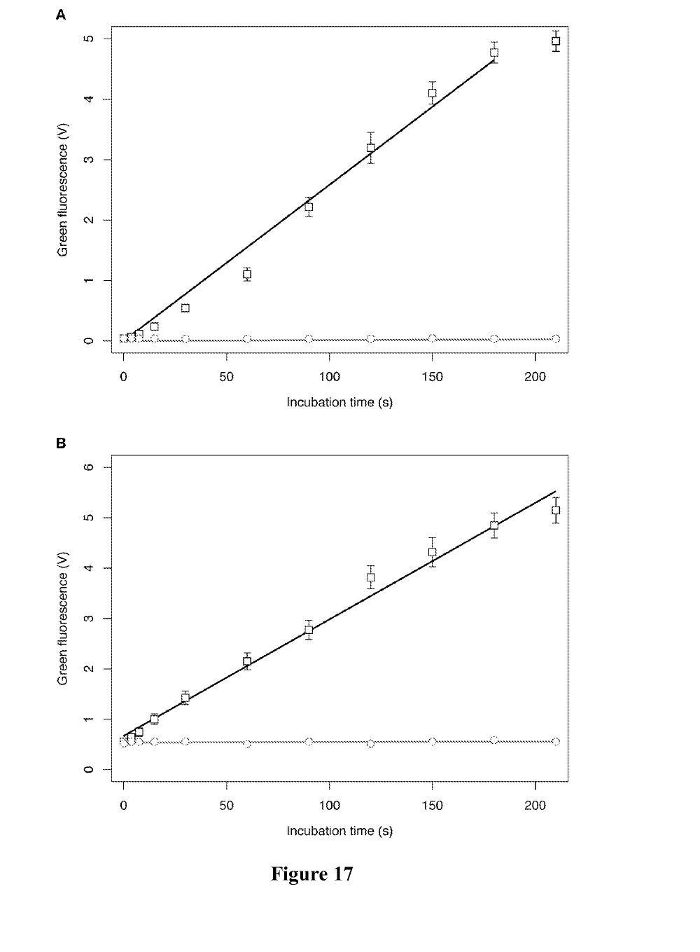

PBS was pumped through the autosampler at a rate of 200 μl/hour. On-chip, this flow was combined with solutions of enzyme and substrate, both flowing at 100 μl/hour. The enzyme solution was 20 U/ml of E. coli Grade VIII β-galactosidase in PBS containing 4 g/l BSA. The substrate solution was 240 μM FDG and 400 nM sodium fluorescein in PBS. The combined aqueous flow was segmented into droplets by the oil/surfactant solution flowing at a rate of 400 μl/hour. The optical setup was positioned just before the delay line and individual droplets were discriminated by green fluorescence. The measurement at this point provided a “pseudo blank” (no enzyme activity, equivalent to 100% inhibition) for the inhibition calculations later on: droplets with zero activity were not observed to change fluorescence between production and any measurement point in the delay line (FIG. 17).

The optical setup was repositioned to the 30-second measurement point and the droplets were analyzed continuously. Meanwhile, the autosampler was used to load 1 μl from each well of a 96-well plate into the PBS stream running through the dispersion capillary. Each well contained 20 μl of 100 μM DY-682 in PBS, plus one of four different concentrations of the inhibitor 2-phenylethyl β-D-thiogalactoside (PETG; Invitrogen Corp., California, USA): 600 μM (“high”), 120 μM (“medium”), 24 μM (“low”), or zero. As each Gaussian-like pulse of DY-682 and PETG, mixed with the reaction components and segmented into droplets, arrived at the optical detector, a dose-response profile was recorded.

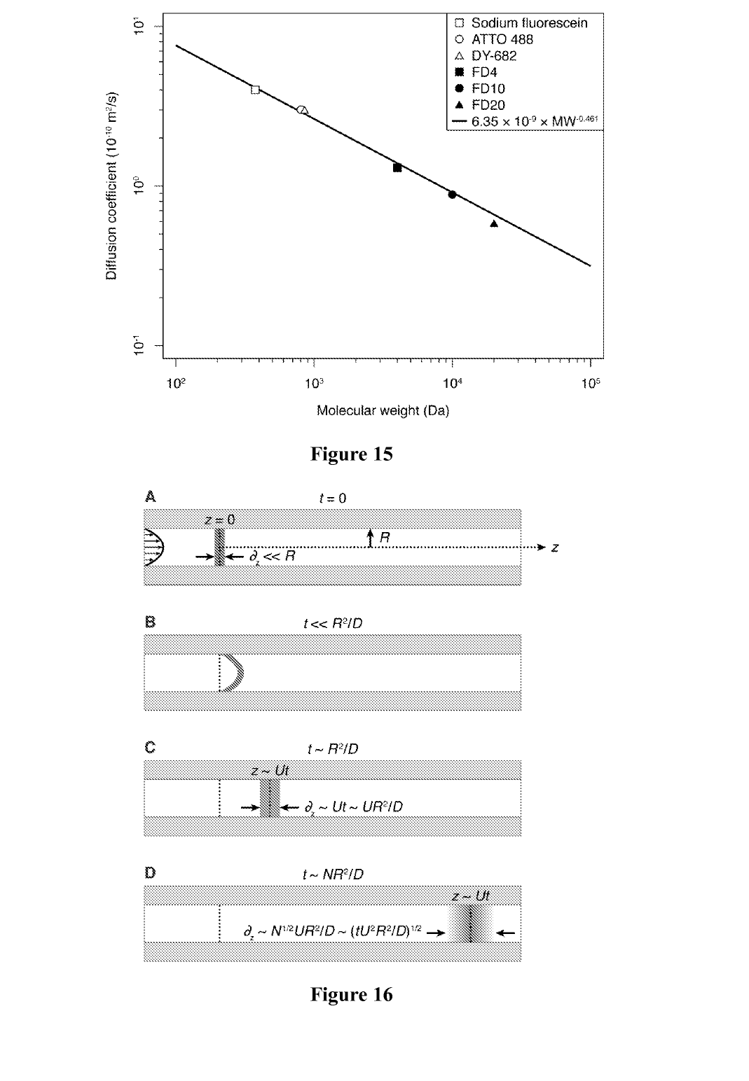

Offline, a Python script was used to group the droplets in the front edge of each Gaussian-like pulse by injection (˜10,000 droplets); these droplets are referred to as the injection's “dose-response droplets”. 1 second's worth of droplets directly preceding each Gaussian-like pulse were also stored (˜800 droplets). The mean green fluorescence of these droplets provided the “control” value (0% inhibition) for the injection and this value was used with the pseudo blank value (corresponding to 100% inhibition) to calculate the percentage inhibition in the subsequent dose-response droplets. As high DY-682 concentrations were observed to quench green fluorescence to some extent, the NIR fluorescence signal for each droplet was used to correct the green fluorescence signal. The corrected green signal was then used to calculate the proportion of inhibition (I) in each droplet using the following equation:

$$I = 1 - \frac{M - B}{C - B} \qquad ( 1 )$$

where M is corrected measured fluorescence, B is the pseudo blank value, and C is the control value. In parallel, the NIR fluorescence signal for each droplet was used to calculate the concentration of co-injected compound. This was achieved in the following way: (i) the fitted curve of NIR fluorescence against time for DY-682 (FIG. 11) was plotted for the first half of the Gaussian-like pulse using Equation 8 (Eq. 8) described above; (ii) the time value (t) for the crossing point of the curve at a C value equal to the droplet's NIR fluorescence was identified; (iii) compound concentration at time t was calculated using Eq. 8 with the same parameters as in the first step, except D, which was predicted for the compound using the relationship show in FIG. 15. The dose-response droplets were then sorted into 28 bins spaced equally over a logarithmic scale from 0.1 to 50 μM with droplets falling outside this range being ignored. For each bin, the mean percentage inhibition value was found by averaging the values for the droplets within it. These mean values were then plotted against compound concentration for each well of the 96-well plate. A script written in R was used to fit these points with the 4-parameter Hill function:

$$y = {y}_{min} + \frac{{y}_{max} - {y}_{min}}{1 + {( \frac{x}{{IC}_{50}} )}^{H}} \qquad ( 2 )$$

where y is proportion of inhibition, yₘᵢₙ is the lower asymptote of the curve (minimum inhibition), yₘₐₓ is the upper asymptote (maximum inhibition), x is the concentration of compound, and H is the Hill slope. The IC₅₀ is the remaining fitted parameter and, as such, is easily extracted.

For each of the 16 “medium” injections the quality of the assay was determined by calculating the Z-factor (Zhang et al., 1999). The control values were the fluorescence values for the “control” droplets in the injection (0% inhibition), while the sample values were for the droplets containing 50 μM PETG (yielding 97.5% inhibition).

$${Z}_{i} = 1 - \frac{( 3 {σ}_{s} + 3 {σ}_{c} )}{\vert {μ}_{s} - {μ}_{c} \vert} \qquad ( 3 )$$

where Zᵢ is the Z-factor for injection i, μₛ and σₛ are the mean and standard deviations of the sample droplets, and μ_{c} and σ_{c} are the respective values for the control droplets. The 16 Z-factors were then averaged together to give the Z-factor value mentioned in the main text.

High-Resolution Dose-Response Screening of PTP1B Inhibition with a Chemical Library

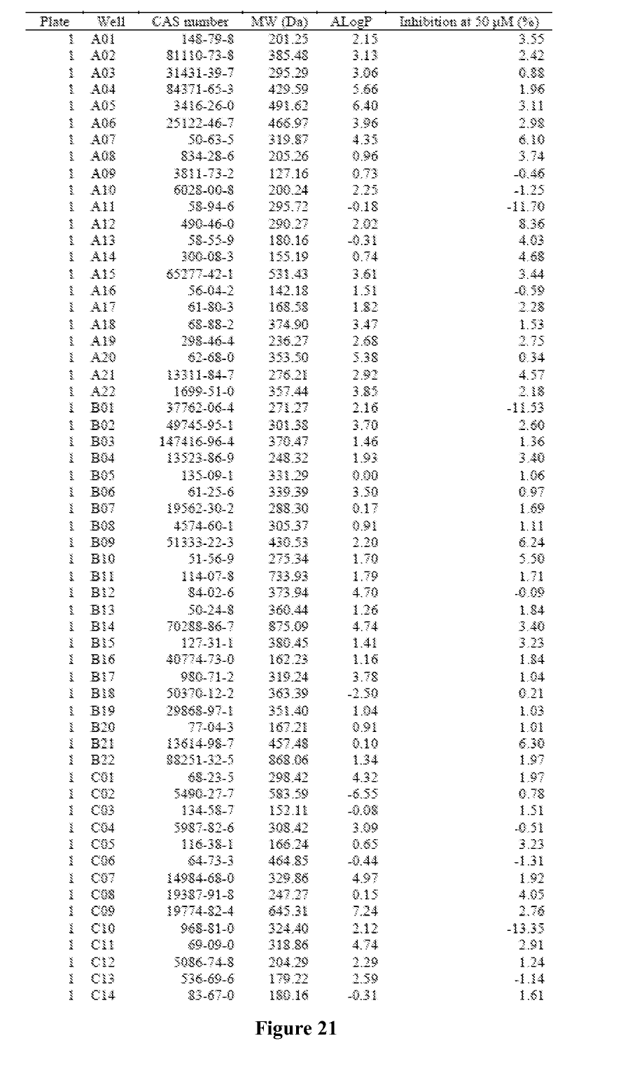

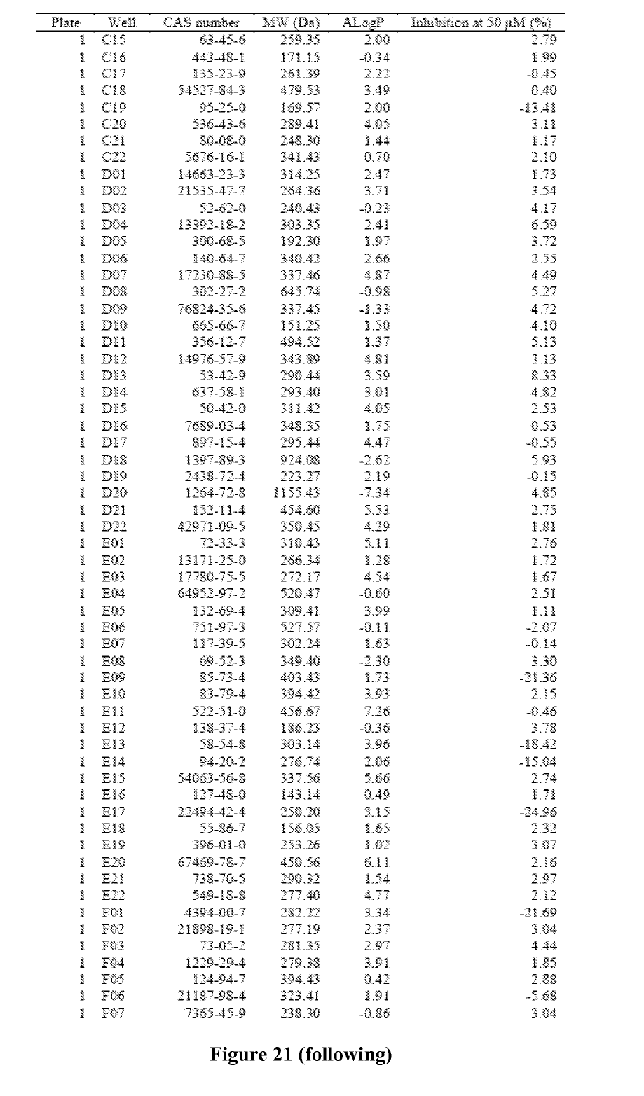

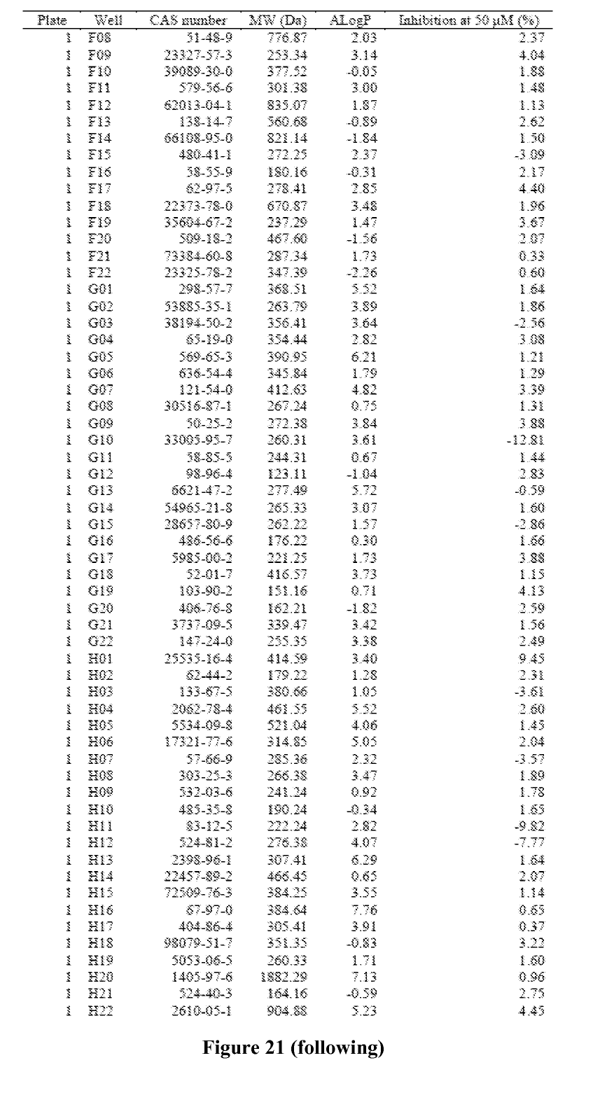

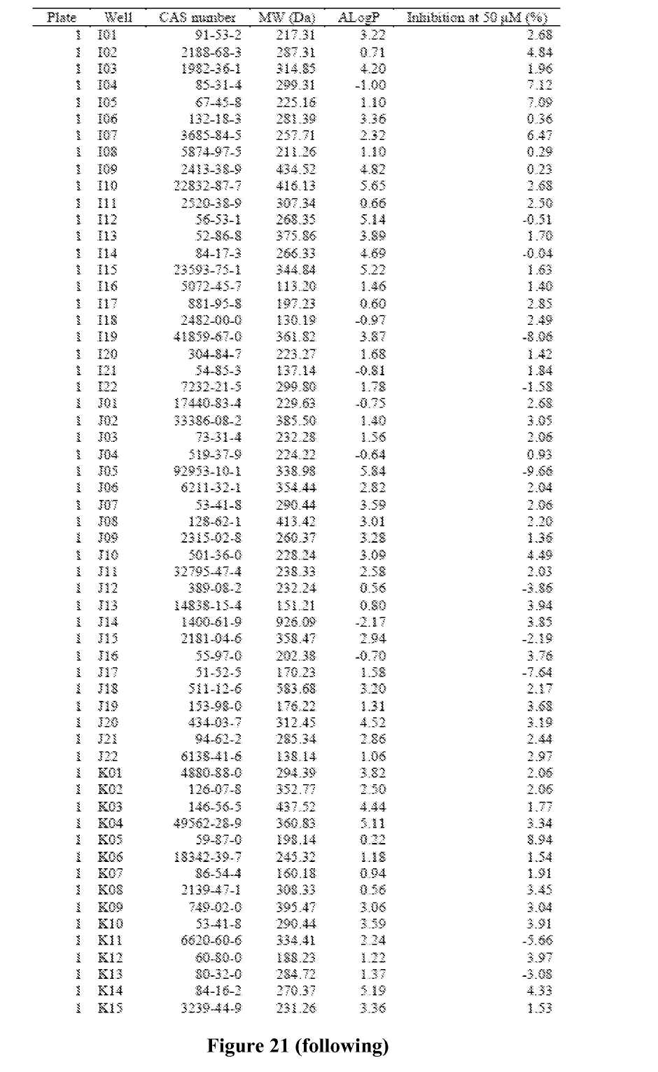

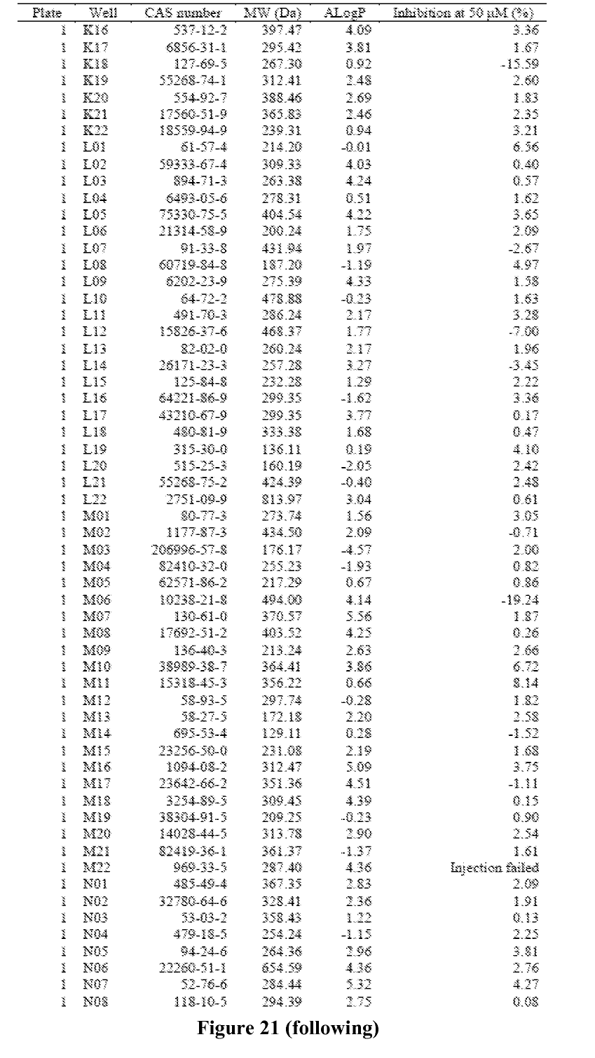

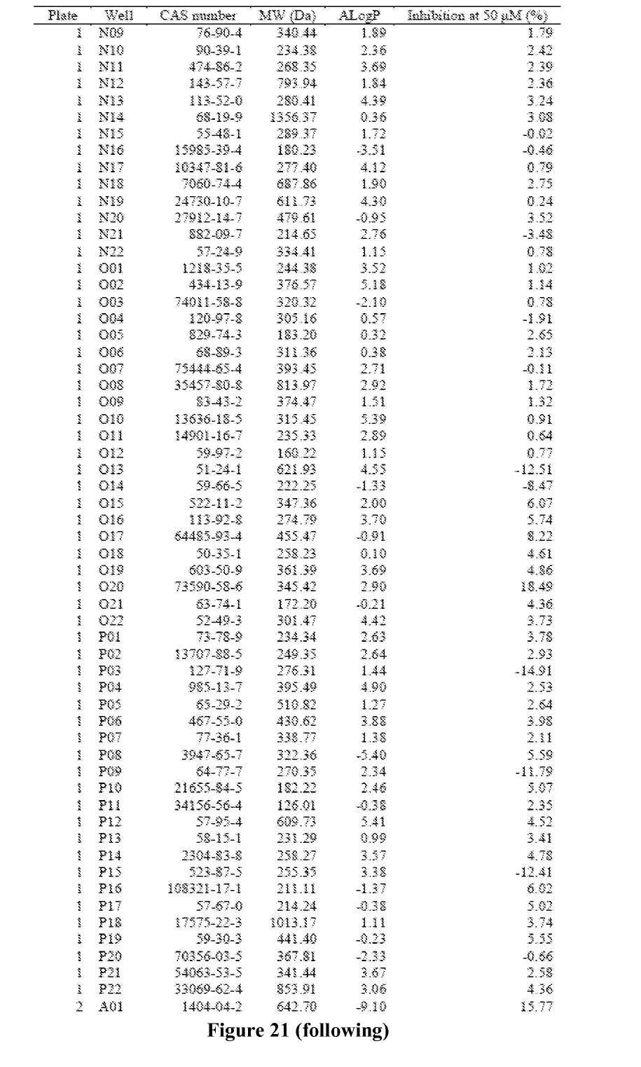

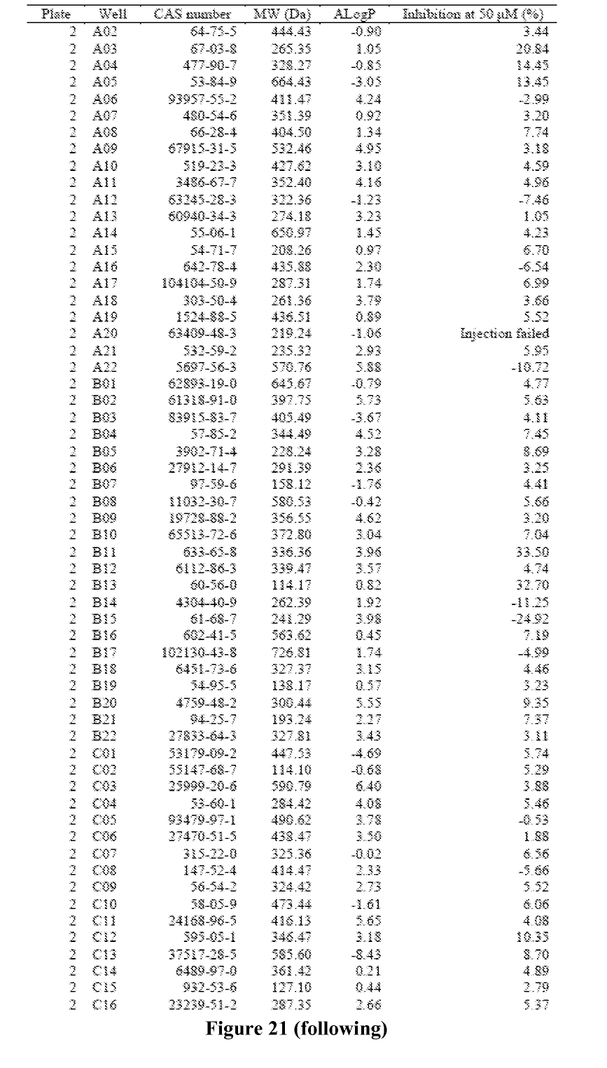

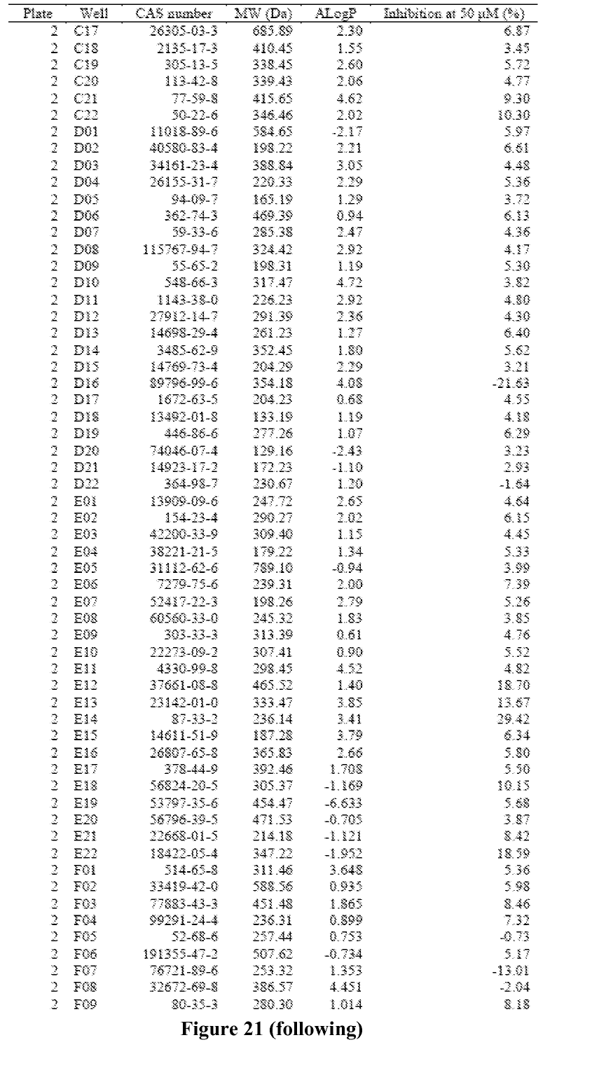

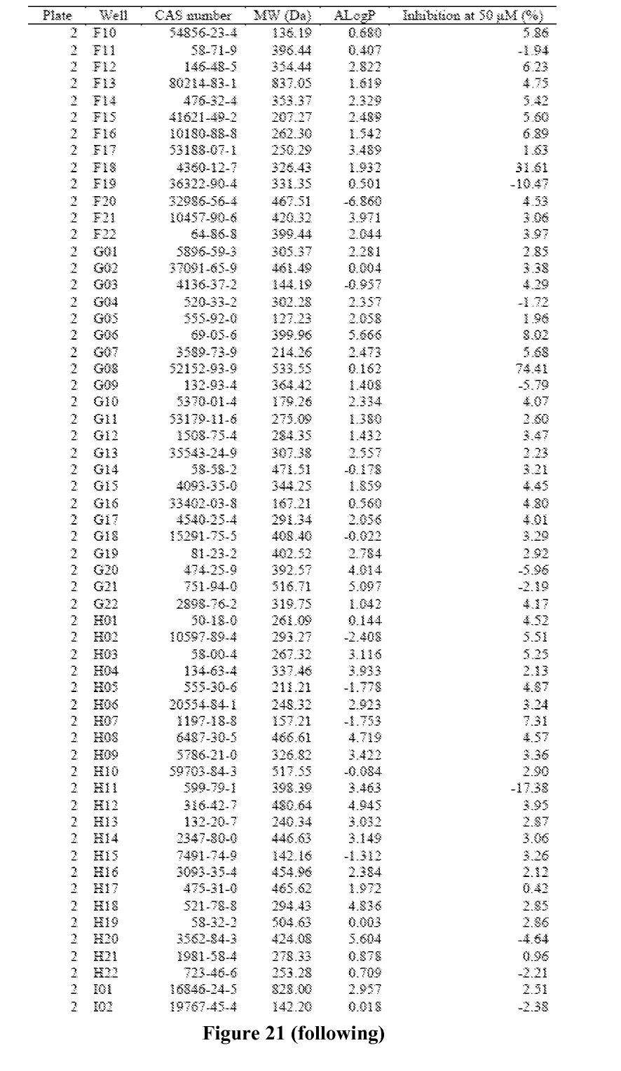

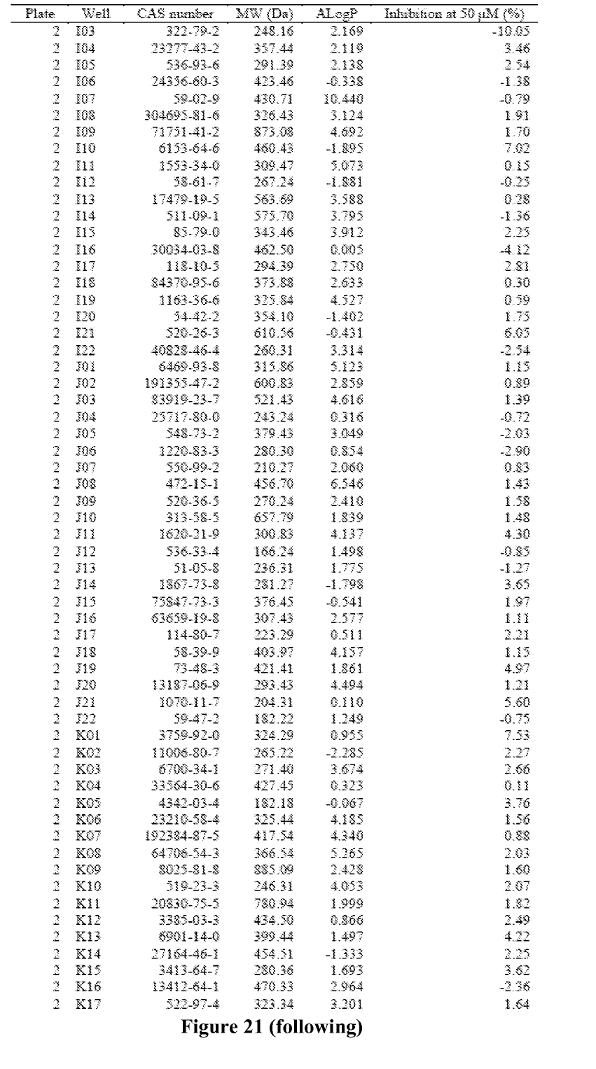

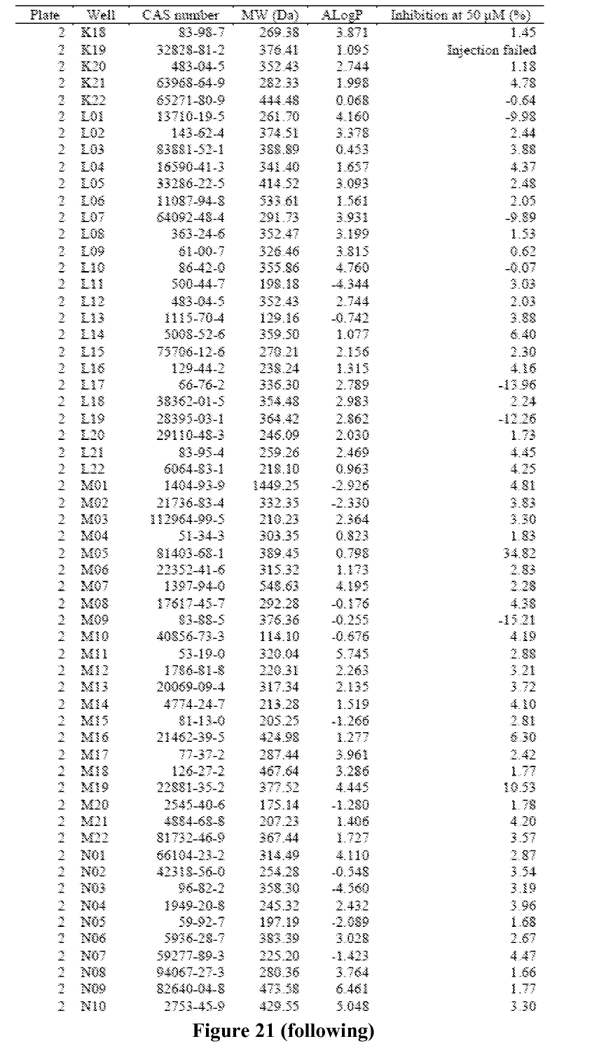

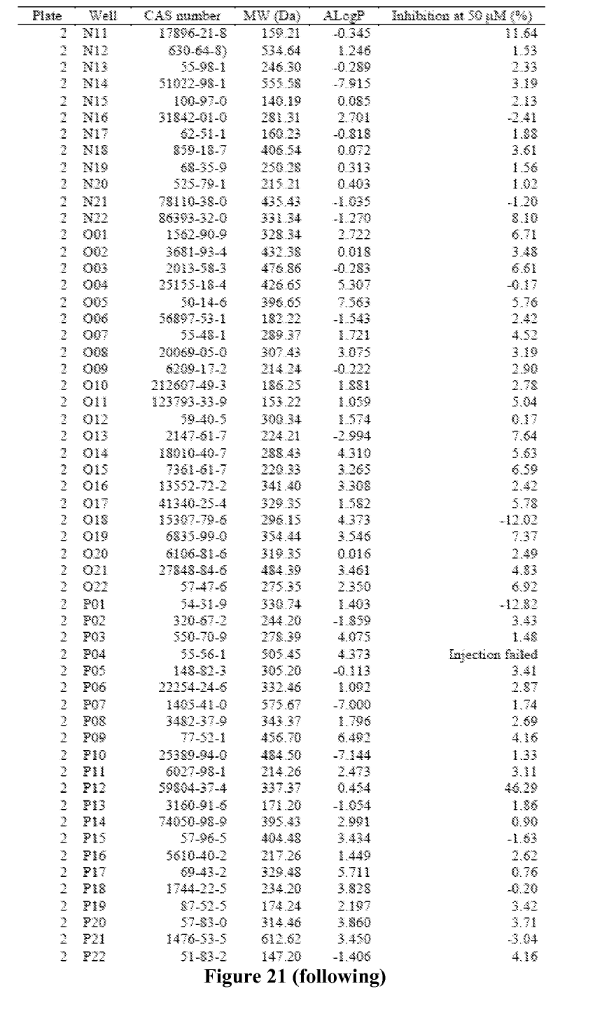

High-resolution dose-response screening of PTP1B inhibition was performed in a similar manner to the screening of β-galactosidase inhibition (see above), but with the following changes: 50 mM HEPES pH 7.2 was used in place of PBS; the enzyme solution was 20 mg/l PTP1B in 50 mM HEPES pH 7.2 containing 4 mM DTT, 4 mM EDTA, and 4 g/l BSA; and the substrate solution was 68 μM FDP in 50 mM HEPES pH 7.2. In place of the 96-well plate were two 384-well plates containing 704 compounds comprising a subset of the Prestwick Chemical Library® (FIG. 21). These plates were prepared by diluting 1 μl aliquots of the compounds in pure DMSO to 10 μl of 240 μM concentration in 50 mM HEPES pH 7.2 by serial dilution. The compounds occupied columns 1 to 22 of each plate, while the wells in column 23 contained 10 μl of 240 μM sodium suramin (in the same buffer) and the wells in column 24 contained 10 μl of buffer alone.

Injections were performed as described above. Data processing did not, however, correct for differences in dispersion between the NIR dye and the compound co-injected. In this case the dispersion coefficients were assumed to be identical and the compound concentration in each droplet was calculated by assuming a linear correlation between NIR fluorescence and compound concentration. Consequently, the Hill slope and IC50 values of fits of the 4-parameter Hill function are less accurate. The mean Z-factor for the assay was determined using 16 injections of the known inhibition sodium suramin (the 50 μM droplets were inhibited 89.9%).

Microplate Dose-Response Assays

For β-galactosidase, a solution of the inhibitor PETG was diluted to 200 μM in PBS and then further diluted in 3-fold serial dilution steps seven times (200 μM down to 22.9 nM). 10 μl aliquots of each dilution were pipetted into the wells of a black, opaque 384-well plate (Corning, Inc., New York, USA). A stock of the substrate FDG was diluted to 240 μM in PBS and 10 μl aliquots were added to the wells. The reactions were initiated by adding 20 μl of 10 U/ml β-galactosidase, in PBS containing 2 g/l BSA, to each well. A SpectraMax M5 microplate reader (Molecular Devices, Inc., California, USA) was used to monitor the reactions at 25° C. with an excitation wavelength of 490 nm, an emission wavelength of 514 nm (automatic cut-off), and a 15 second period between measurements. The initial rate of each reaction was determined and the percentage inhibition of β-galactosidase activity was calculated by scaling this initial rate between a blank (no enzyme, equivalent to 100% inhibition) and a positive control (no inhibitor, equivalent to 0% inhibition) in the same manner as Eq. 1 (see above). When required, the 4-parameter Hill function was fitted to a plot of percentage inhibition against logged inhibitor concentration to determine the IC₅₀ of PETG.

For PTP1B, the same approach was used with the following alterations: the inhibitor was diluted in 50 mM HEPES pH 7.2; the solution of enzyme was 10 mg/l PTP1B (EMD Biosciences, Inc., California, USA) in 50 mM HEPES pH 7.2 containing 2 mM DTT, 2 mM EDTA, and 2 g/l BSA; and the solution of substrate was 68 μM FDP in 50 mM HEPES pH 7.2. Dose-response profiles were collected for the following compounds: the known inhibitor sodium suramin, the novel inhibitor sodium cefsulodin, the novel weak inhibitor methimazole, and the novel weak activator diflunisal.

Results

An autosampler loaded pulses of compounds pre-mixed with a near-infrared (NIR) fluorescent dye from a 384-well microplate into a continuous stream of buffer. The buffer passed through a capillary where Taylor-Aris dispersion transforms the rectangular concentration profiles of the compound and the dye into superimposed Gaussian-like profiles (FIG. 10E). The flow from the capillary passed into a microfluidic device where it was combined with the assay components (the target enzyme and a fluorescein-based fluorogenic substrate) and then segmented by a stream of fluorinated oil containing a surfactant. Each 120 pl droplet functioned as an independent microreactor, restricting further dispersion of the compound and NIR dye. After production, the droplets were incubated in an on-chip delay line, allowing time for the enzymatic reaction to proceed, and then passed one at a time through a double laser spot where the fluorescence of each droplet was measured. NIR fluorescence intensity was used to infer the concentration of NIR dye and, by taking account of differences in their dispersion profiles, that of the co-injected compound. In parallel, it was possible to measure the degree of enzyme inhibition in the droplet from the green fluorescence of the product of the enzymatic reaction (fluorescein). Offline, the droplets in the rising phase of the Gaussian-like profile for each compound were plotted on a graph of enzyme inhibition versus compound concentration and a high-resolution dose-response curve was constructed.

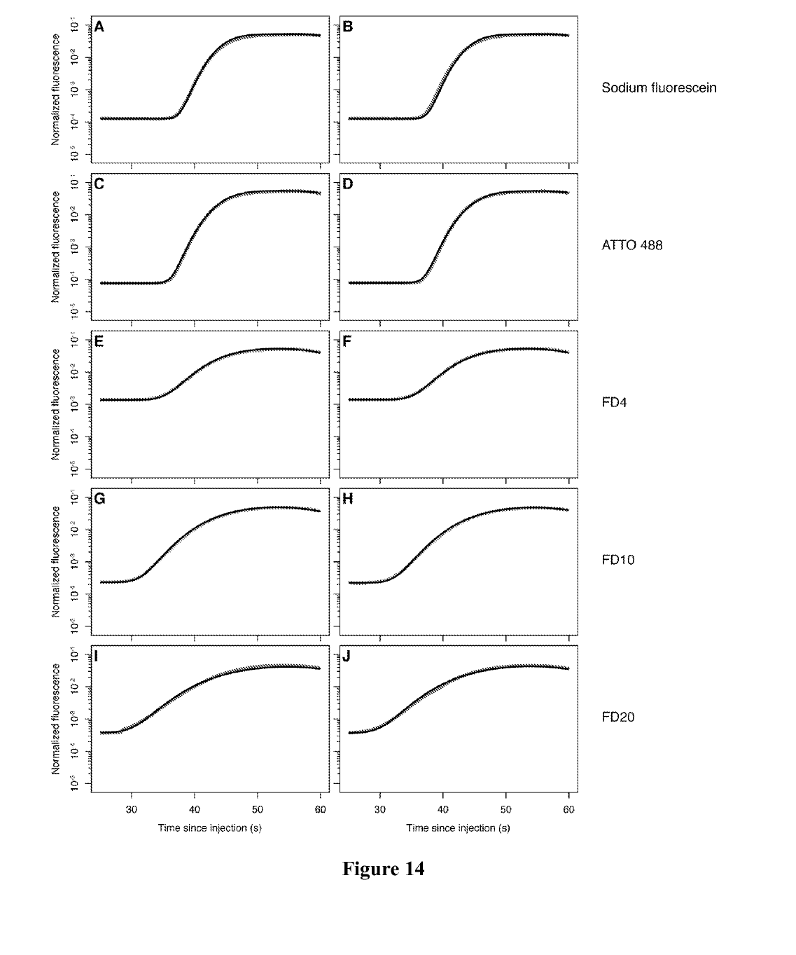

The system of the invention was characterized using six fluorophores with different molecular masses (376 to 20,000 Da). A buffer was pumped through the capillary and 1 μl of each fluorophore was sequentially injected into the flow. On-chip, the fluorescence of the flow was monitored as each pulse arrived at the chip and was segmented into droplets. The fluorescence profiles obtained for the NIR dye DY-682 (FIGS. 11, 12 and 13) and the five other fluorophores (FIGS. 13 and 14) closely fitted a model for Taylor-Aris dispersion. The diffusion coefficients (D) calculated from the dispersion were close to the expected values and scaled as roughly the inverse of the cube root of the molecular mass, as expected (FIG. 15). Hence, under the same flow conditions, the dispersion profile of a molecule is simply a function of its D value and, thus, its molecular weight. Via a numerical approach, this allows the concentration of a compound in a droplet to be determined from the concentration of a co-injected fluorophore possessing a different D. This approach contrasts with capillary electrophoresis and ultra performance liquid chromatography separation systems, which have also been integrated with micro fluidic droplet production, in which the concentration gradients are strongly influenced by the chemical properties of the compounds.

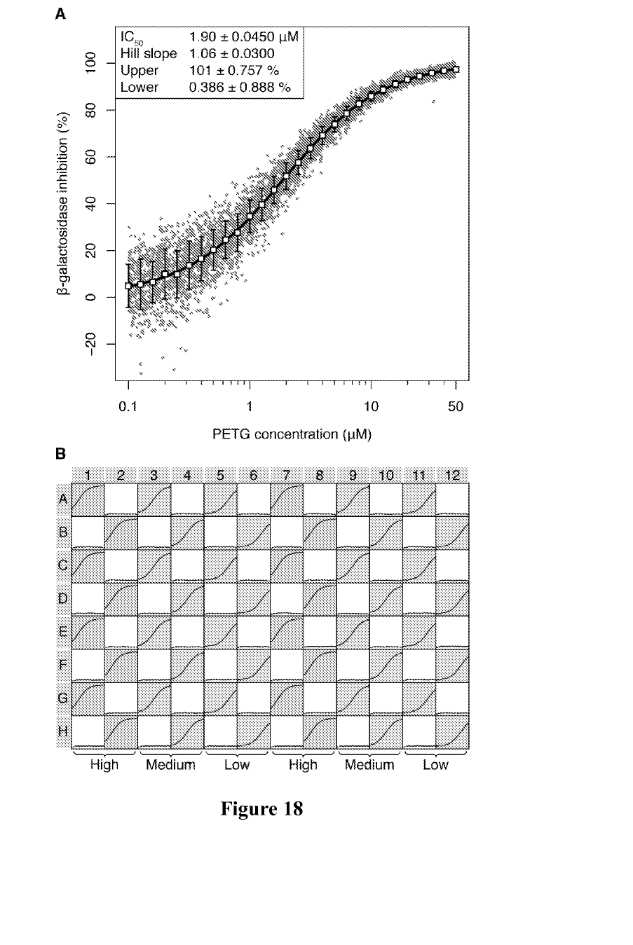

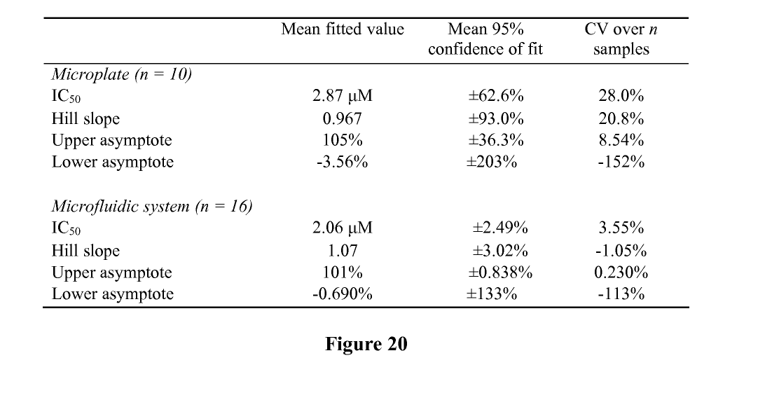

The system of the invention was also characterized by measuring the dose-response relationship of 2-phenylethyl β-D-thiogalactoside (PETG) with the reporter enzyme β-galactosidase. A 96-well plate was prepared with each well containing a fixed concentration of the NIR dye and one of four different concentrations of PETG (including zero). As before, 1 μl was injected from each well and the flow from the capillary was combined with β-galactosidase and the fluorogenic substrate fluorescein di-β-D-galactopyranoside (FDG) on-chip. Droplets flowed through a 30 second delay line and were analyzed by the optical setup to determine the initial rate (FIG. 17). A dose-response curve was constructed for each injection (FIG. 18) and then fitted with the 4-parameter Hill function. The IC₅₀ calculated for each injection of inhibitor (mean IC₅₀=2.06 μM) was found to be in agreement with the value obtained in microplate (2.72 μM; FIGS. 18, 19 and 20) and the literature value (3.10 μM) (Angenendt et al., 2004). The precision of the IC₅₀ value was, however, found to be much higher in the micro fluidic system than in a conventional 8-point microplate assay: for a single injection the 95% confidence interval was, on average, ±2.49% versus ±62.6% in microplate. Furthermore, the results are highly reproducible: the coefficient of variation (CV) for the IC₅₀ was 3.55% (n=16), compared to 28.0% in microplate (n=10). Cross-contamination between injections was less than 0.14%, and the Z-factor was 0.686, indicating that it was an excellent assay (Zhang et al., 1999).

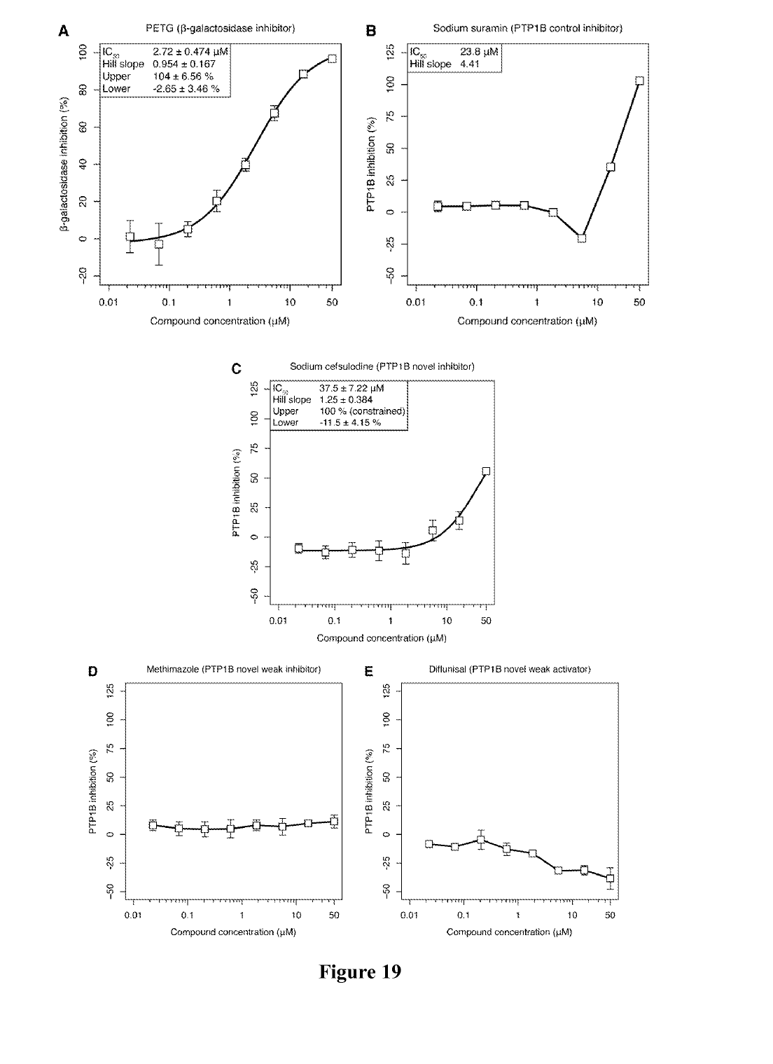

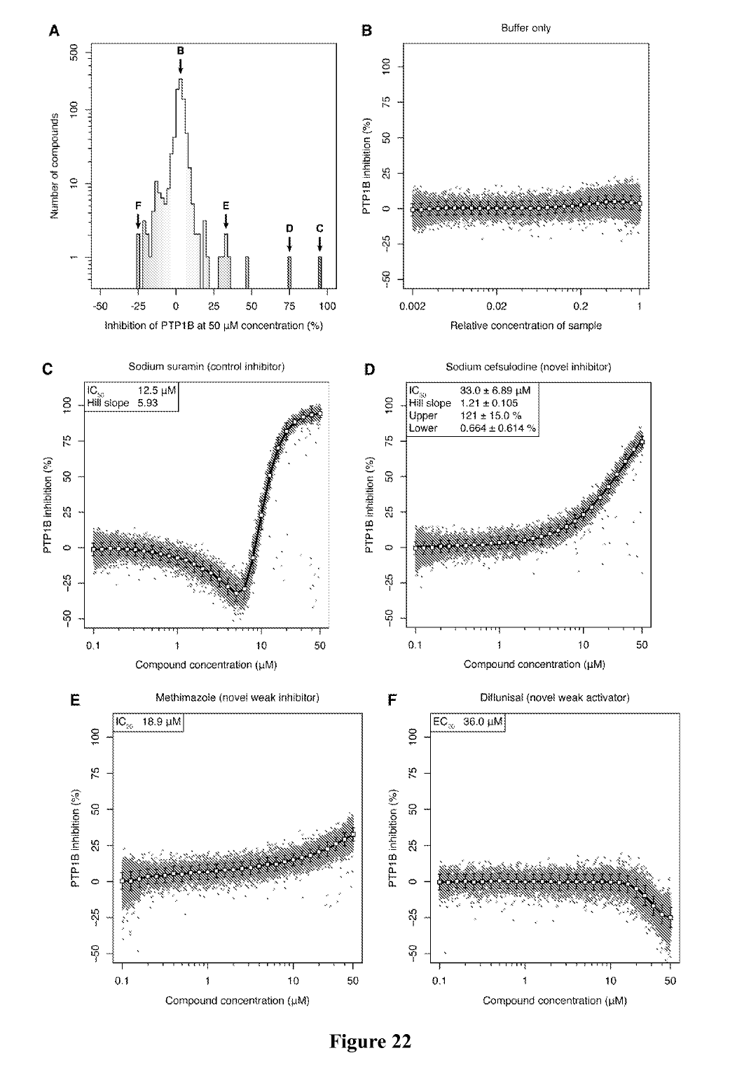

Furthermore, a chemical library comprising 704 compounds from the Prestwick Chemical Library® (all marketed drugs with molecular masses between 113 and 1,882 Da; FIG. 21) was screened against protein tyrosine phosphatase 1B (PTP1B), a target for type 2 diabetes mellitus, obesity and cancer (Yip et al., 2010). In this case, fluorescein diphosphate (FDP) was used as the fluorogenic substrate and sodium suramin, a potent known inhibitor of PTP1B (Zhang et al., 1998), was used as the positive control. The Z-factor for the assay was 0.671, indicating that it was excellent (Zhang et al., 1999). Eight compounds exhibited inhibitory behavior with IC₂₀ values less than 50 μM, while five compounds activated the enzyme with EC₂₀ values less than 50 μM (FIGS. 22 and 23). One of the inhibiting compounds, sodium cefsulodine, exhibited strong inhibition of PTP1B (IC₅₀=33.0 μM). Its inhibitory activity was confirmed in microplate (FIG. 19C), as was the activatory activity of the novel weak activator diflunisal (FIG. 19E). The inhibitory activity of the novel weak inhibitor methimazole was not confirmed in microplate (FIG. 19D), but this may have been due to the limited sensitivity of the microplate assay. Interestingly, the known inhibitor sodium suramin was seen to activate PTP1B at low concentrations (<10 μM) and inhibit it at higher concentrations (FIG. 22C) in the high-resolution dose-response curves. This complex dose-response relationship, which was confirmed in microplate (FIG. 19B), would have been missed in a single-point primary screen and is likely to have been classified as artefactual in a 7-10 point dose-response study.

### Example 3

### Materials and Methods

Analytical Workstation

The analytical workstation was the same as in the above section Analytical workstation in Example 2.

Microfluidic Devices

Microfluidic devices were fabricated in the manner described in the above section Microfluidic devices in Example 2.

The dilution module ran with a constant flow-rate of 111 μl/hr for the compound inlet and 389 μl/hr for the dilution buffer, leading to a total flow rate of 500 μl/hr flowing into the gradient channel. The withdraw pumps ran a program of ramps of 10 or 20 μl/hr steps every 200 ms between 20-430 μl/hr (vice-versa) in order to maintain a constant flow-rate of 50 μl/hr exiting the dilution module. This flow was supplemented with enzyme and substrate, if necessary, and then passed through a nozzle with a height of 25 μm and a width of 25 μm. HFE-7500 containing 1% (w/w) EA surfactant (RainDance Technologies, Inc., Massachusetts, USA), a biocompatible PEG-PFPE amphiphilic block copolymer, flowing at 400 μl/hr segmented the aqueous stream into droplets. The droplets were produced at a rate of ˜500 per second, indicating that they had a volume of ˜90 μl each.

Results

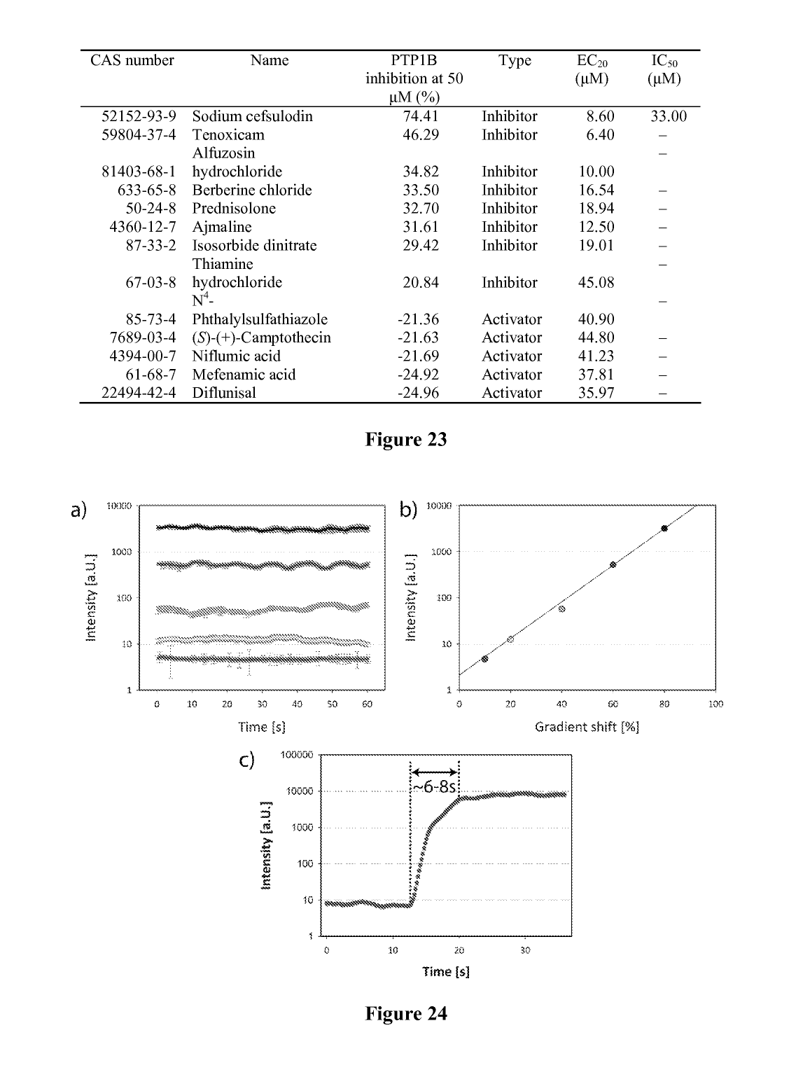

A resistor network forming a dilution gradient with five outlet channels: C=[C₀, 0.1C₀, 0.01C₀, 0.001C₀, 0] was designed in order to test and validate the system according to the invention. The device should be therefore capable of covering a little more than three orders of magnitude in dilution when feeding this gradient into the scanning region. The reason for choosing this range results from the detection system which is limited to about three orders of magnitude in fluorescent signal-to-background detection. The device was tested with a solution of 100 μM fluorescein in PBS and the fluorescence of the resulting droplets was recorded at the outlet. FIG. 24a shows time-lines for different adjusted gradient shifts, each one held for at least 60 s. As expected, there was some signal noise due to pump fluctuations. Nevertheless, the adjusted concentrations were within a well-defined range at any time and, even more importantly, there was no difference in percentage noise for higher or lower adjusted concentrations. This would have been fundamentally different when using a simple co-flow system. Furthermore, the results shown in FIG. 24b confirm the expected exponential behavior when shifting the gradient.

Another parameter characterizing this system is the switching time or the dynamic behavior. A custom software controlled the syringe pumps allowing to change the withdraw rates on both sides of the scanning region simultaneously. Switching the concentration, as shown in FIG. 24c, from its lowest possible value to its highest took, on average, 6-8 s.

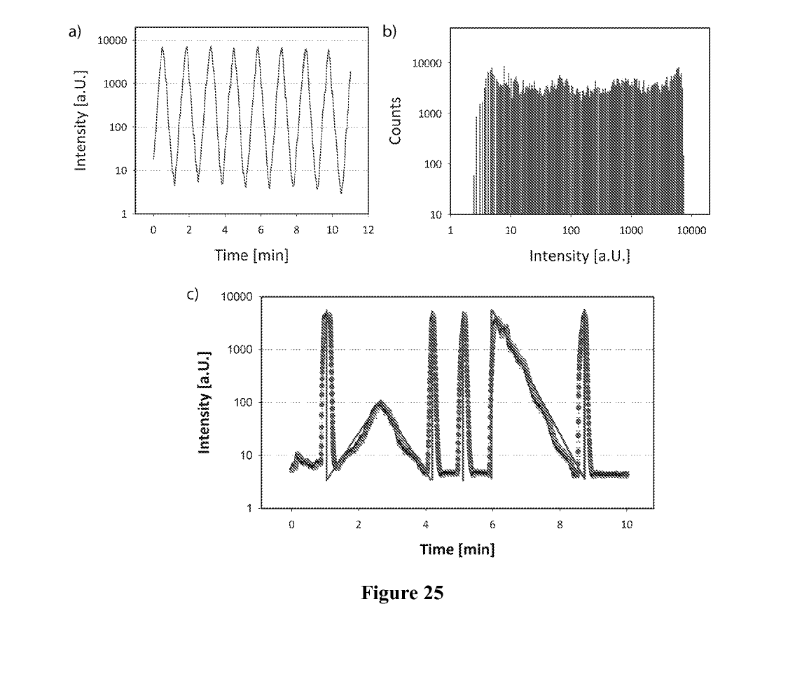

For practical applications in concentration dependent screening it is useful to ramp the concentration and perform saw-tooth functions. The time-line in FIG. 25a shows such a recorded function and indicates the reproducibility. The fastest ramps tested needed 16 s to cover the entire dilution range. FIG. 25b shows the recorded histogram. It can be seen that the system uniformly covers the whole dilution range without over- or under-sampling certain regions, which is also an indicator for the stability and precision in adjusting the different dilutions. At the lowest concentrations, the limit of the fluorescence detection system was reached, which led to the detection noise visible towards the left of the histogram.

These tests confirm that the dilution system is highly flexible and is capable of performing any desired concentration function in time. FIG. 25c shows an example of a recorded concentration function programmed to perform a variety of step-function, ramps and holding a certain concentration over well defined time-periods. In this example the system was programmed to create functions representing certain letters. Performing several of these letter-functions in a row generated the output signal in FIG. 25c which can be read as the word ‘WIN’.

This invention has been described with reference to various specific and exemplary embodiments and techniques. However, it should be understood that many variations and modifications will be obvious to those skilled in the art from the foregoing detailed description of the invention and be made while remaining within the spirit and scope of the invention.

### REFERENCES

K. Ahn, J. Agresti, H. Chong, M. Marquez and D. A. Weitz, Appl. Phys. Lett., 2006, 88, 264105-264103
P. Angenendt et al., Anal Chem 76, 1844 (2004).
S. Anna, N. Bontoux and H. Stone, Formation of dispersions using “flow focusing” in microchannels, Appl. Phys. Lett., 2003, 82, 364-366.
R. Aris, Proc. R. Soc. Lond. A 235, 67 (1956).
J. C. Baret et al., Fluorescence-activated droplet sorting (FADS): efficient microfluidic cell sorting based on enzymatic activity, Lab Chip, 2009, 9(13), 1850-1858.
C. N. Baroud, M. R. de Saint Vincent and J. P. Delville, Lab Chip, 2007, 7, 1029-1033
E. Brouzes et al., Droplet microfluidic technology for single-cell high-throughput screening, Proc. Natl. Acad. Sci. USA, 2009, 106(34), 14195-14200.
J. Clausell-Tormos et al., Droplet-based microfluidic platforms for the encapsulation and screening of mammalian cells and multicellular organisms, Chem. Biol., 2008, 15(8), 427-437.
F. Courtois et al., An integrated device for monitoring time-dependent in vitro expression from single genes in picolitre droplets, Chembiochem., 2008, 9(3), 439-446.
Christopher and Anna (2007) J. Phys. D: Appl. Phys. 40, R319-R336
L. M. Fidalgo, C. Abell and W. T. S. Huck, Lab Chip, 2007, 7, 984-986
L. Frenz, A. El Harrak, M. Pauly, S. Begin-Colin, A. D. Griffiths, and J. C. Baret, Droplet-based microreactors for the synthesis of magnetic iron oxide nanoparticles, Angew. Chem. Int. Ed. Engl., 2008, 47(36), 6817-20.
A. Griffiths, Proc. Phys. Soc. London 23, 190 (1910).
K. E. van Holde, W. C. Johnson and P. S. Ho. Principles of physical biochemistry (2nd Edition). Pearson Prentice Hall, Upper Saddle River, N.J. (2006).
C. Holtze et al., Biocompatible surfactants for water-in-fluorocarbon emulsions, Lab Chip, 2008, 8, 1632-1639
L. H. Hung, K. M. Choi, W. Y. Tseng, Y. C. Tan, K. J. Shea and A. P. Lee, Lab Chip, 2006, 6, 174-178
X. Jiang, J. M. K. Ng, A. D. Stroock, S. K. W. Dertinger, and G. M. Whitesides, A miniaturized, parallel, serially diluted immunoassay for analyzing multiple antigens, J. Am. Chem. Soc., 2003, 125(18), 5294-5295.
P. Kapusta, “Absolute diffusion coefficients: compilation of reference data for FCS calibration”, Application Note by PicoQuant GmbH (Berlin, Germany) (2010).
Oliver Keminer and Reiner Peters, Permeability of Single Nuclear Pores, Biophysical Journal, Volume 77, July 1999, 217-228.
L. Li, J. Q. Boedicker and R. F. Ismagilov, Anal. Chem., 2007, 79, 2756-2761
D. R. Link, E. Grasland-Mongrain, A. Duni, F. Sarrazin, Z. D. Cheng, G. Cristobal, M. Marquez and D. A. Weitz, Angew. Chem., Int. Ed., 2006, 45, 2556-2560
Y. Liu and R. F. Ismagilov, Langmuir, 2009, 25, 2854-2859
Mazutis, L. Baret, J.-C. and Griffiths, A. D. Lab Chip, 2009, 9, 2665-2672
L. Mazutis et al., Droplet-based microfluidic systems for high-throughput single DNA molecule isothermal amplification and analysis, Anal. Chem., 2009, 81(12), 4813-4821.
X. Niu, S. Gulati, J. B. Edel and A. J. deMello, Lab Chip, 2008, 8, 1837-1841
C. Priest, S. Herminghaus and R. Seemann, Appl. Phys. Lett., 2006, 89, 134101
R Development Core Team, R: A language and environment for statistical computing, R Foundation for Statistical Computing, Vienna, Austria, 2009, ISBN 3-900051-07-0.
C. Ritz and J. C. Streibig, Bioassay Analysis using R, J. Statist. Software, 2005, 12(5).
F. Sassa, J. Fukuda and H. Suzuki, Anal. Chem., 2008, 80, 6206-6213
I. Shestopalov, J. D. Tice and R. F. Ismagilov, Lab Chip, 2004, 4, 316-321
H. Song, J. D. Tice and R. F. Ismagilov, Angew. Chem., Int. Ed. Engl., 2003, 42, 767-772
Y. C. Tan, Y. L. Ho and A. P. Lee, Microfluid. Nanofluid., 2007, 3, 495-499.
G. I. Taylor, Dispersion of soluble matter in solvent flowing slowly through a tube, Proc. Roy. Soc. A., 1953, 219(1137), 186-203.
G. Taylor, Proc. R. Soc. Lond. A 219, 186 (1953).
G. Taylor, Proc. R. Soc. Lond. A 225, 473 (1954).
E. Um and J. K. Park, Lab Chip, 2009, 9, 207-212
S. C. Yip, S. Saha, J. Chemoff, Trends in biochemical sciences, (2010).
Y. L. Zhang, Y. F. Keng, Y. Zhao, L. Wu, Z. Y. Zhang, J Biol Chem 273, 12281 (1998).
J. H. Zhang, T. D. Chung, K. R. Oldenburg, J Biomol Screen 4, 67 (1999).

1-50. (canceled)

51. A method for generating variable concentration of a solute in microdroplets, said method comprising:
(a) flowing a solvent into a microfluidic channel in a laminar manner;
(b) introducing a pulse of a solute to the stream of solvent;
(c) flowing the stream containing the solvent and the solute along the channel; and
(d) generating microdroplets by combining the output stream of the channel with an oil phase, said microdroplets containing variable concentration of the solute.

52. The method according to claim 51, wherein during step (c) the solute disperses into the solvent due to Taylor-Aris dispersion.

53. The method according to claim 52, wherein the method further comprises calculating the concentration of the solute in microdroplets generated in step (d) using the theoretical Taylor-Aris dispersion and the diffusion coefficient of the solute.

54. The method according to claim 53, wherein the method further comprises measuring the diffusion coefficient of the solute.

55. The method according to claim 54, wherein the diffusion coefficient of the solute is measured by determining the concentration profile of the solute after step (c) and before step (d) and calculating the diffusion coefficient of the solute using the following equation representing the concentration of the solute (C) at a fixed point (Lₘ) in the channel as a function of time (t)
$$C ( {L}_{m} , t ) = \frac{{C}_{0}}{2} ( erf \frac{{L}_{m} + {L}_{p} - Ut}{\sqrt{4 {D}_{eff} t}} - erf \frac{{L}_{m} - Ut}{\sqrt{4 {D}_{eff} t}} )$$
wherein C₀ is the original concentration of the solute in the pulse, erf( ) is the Gauss error function, Lₚ is the original length of the solute pulse in the microfluidic channel, U is the average velocity of the fluid in the microfluidic channel and D_{eff} is the diffusion coefficient of the solute.

56. The method according to claim 55, wherein the concentration profile of the solute after step (c) and before step (d) is measured using refractive index, UV or IR absorption or mass spectrometry.

57. The method according to claim 53, wherein the method further comprises estimating the diffusion coefficient of the solute from the molecular weight and the shape of the solute.

58. A method for generating variable concentration of a solute in microdroplets, said method comprising:
(a) providing a microfluidic system comprising at least two inlet channels that intersect to form a microfluidic channel, said microfluidic channel comprising three output channels, at least two of which are connected to a separate means for controlling and varying the flow, the central output channel containing the output stream of the channel, said central output channel being in fluid communication with a module for generating microdroplets;
(b) flowing a first fluid in one inlet channel and an at least one second fluid containing a solute in another inlet channel, the interface formed between the fluids in the microfluidic channel persisting for the length of the channel
(c) varying the relative flow rates into the outer output channels; and
(d) generating microdroplets by combining the output stream of the central channel with an oil phase, said microdroplets containing variable concentration of the solute.

59. The method according to claim 58, wherein in step (a) the at least two output channels which are connected to a separate means for controlling and varying the flow, are the two outer output channels.

60. The method according to claim 58, wherein means for controlling and varying the flow are aspirating pumps.

61. The method according to claim 58, wherein step (b) comprises flowing several second fluids, each of these fluids containing a different concentration of the solute.

62. The method according to claim 51, wherein the method further comprises, after step (c) and before or after step (d), the step (c′) of combining the output stream of the channel with one or several additional fluids.

63. The method according to claim 62, wherein at least one additional fluid is contained in an additional set of droplets and the method further comprises, after step (d), the step (d′) of fusing said droplets with droplets generated in step (d).

64. A method for determining a dose-response relationship in an at least two component system, said method comprising:
(1) generating variable concentration of a solute in microdroplets with the method according to claim 62, wherein the solute is a first component of the at least two component system and one additional fluid contains a second component of the system; and
(2) measuring the response of the at least two component system in each microdroplet.

65. The method according to claim 64, wherein the second component is an enzyme.

66. The method according to claim 65, wherein the first component is a substrate of said enzyme.

67. A method for screening, selecting or identifying a compound active on a target component, said method comprising:
(1) providing a library of candidate compounds;
(2) generating for each candidate compound provided in step (1) a population of microdroplets with variable concentration of said candidate compound with the method according to claim 62, wherein the solute is the candidate compound and one additional fluid contains the target component;
(3) measuring the activity of said candidate compounds on the target component in microdroplet; and
(4) identifying candidate compounds which are active on the target component.

68. The method according to claim 67, wherein the target component is selected from the group consisting of nucleic acid, protein, enzyme, receptor, protein complex, protein-nucleic acid complex and cell.

69. A microfluidic system comprising:
a module for generating variable concentration of a solute in a solvent; and
a module for generating droplets connected downstream of the module for generating variable concentration.

70. The microfluidic system according to claim 69, wherein the module for generating variable concentration of a solute in a solvent is a microfluidic channel connected to means for introducing a pulse of solute to a stream of solvent flowing along said channel.
